(19) United States
(12) Patent Application Publication
(10) Pub. No.: US 2014/0255003 A1
(43) Pub. Date: Sep. 11, 2014

(54) SURFACING INFORMATION ABOUT ITEMS MENTIONED OR PRESENTED IN A FILM IN ASSOCIATION WITH VIEWING THE FILM

(71) Applicant: Google Inc., Mountain View, CA (US)

(72) Inventor: Andy Abramson, Sunnyvale, CA (US)

(21) Appl. No.: 13/786,381

(22) Filed: Mar. 5, 2013

(51) Int. Cl. H04N 9/87

(52) U.S. Cl. CPC H04N 9/8715
USPC 386/240; 386/244

(57) ABSTRACT

Systems and methods for surfacing information about items mentioned or presented in a media item in association with consumption of the media item. A system can include a request component that receives a request relating to user interest in a portion of a media during playback of the media and an analysis component that analyzes the request and identifies items in the media that may be associated with the user interest request. The system can further include an association component that retrieves background information regarding the identified items and a presentation component that presents the background information to a user in response to the request.

### TECHNICAL FIELD

This application generally relates to providing additional information to a user about items mentioned or presented in a film during playback of the film.

### BACKGROUND

As a user is watching a video, the user may hear an actor speak of an object, person or place that sparks interest to the user. In another aspect, the user may also see an object, person or place in the video that is of interest to the user. For example, a user may hear an actor speak of Amsterdam and desire to know more information about the city, such as where it is located on map. Currently, after hearing or seeing something of interest in a video, a user typically employs a secondary device and performs a manual search to find additional information about the object, person or place of interest. This processes is time consuming and interruptive to the video watching experience.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates an example system for surfacing information about items mentioned or presented in a media item in association with consumption of the media item in accordance with various aspects and embodiments described herein;

FIG. 2 illustrates an example analysis component for identifying user interest items in a media item in accordance with various aspects and embodiments described herein;

FIG. 3 illustrates an example request component for identifying user interest in a section or object of a media item in accordance with various aspects and embodiments described herein;

FIG. 4 illustrates another example system for surfacing information about items mentioned or presented in a media item in association with consumption of the media item in accordance with various aspects and embodiments described herein;

FIG. 5 illustrates another example system for surfacing information about items mentioned or presented in a media item in association with consumption of the media item in accordance with various aspects and embodiments described herein;

FIG. 6 illustrates an example user interface having additional information about a user interest item presented in accordance with various aspects and embodiments described herein;

FIG. 7 illustrates an example embodiment of an example system for receiving and presenting additional information regarding a user interest item mentioned or presented in a video in accordance with various aspects and embodiments described herein;

FIG. 8 is a flow diagram of an example method for generating information mapping user interest items in a video to segments in which they occur and additional information for the respective user interest items in accordance with various aspects and embodiments described herein.

FIG. 9 is a flow diagram of an example method for surfacing information about items mentioned or presented in media item in association with consumption of the media item in accordance with various aspects and embodiments described herein;

FIG. 10 is a flow diagram of another example method for surfacing information about items mentioned or presented in media item in association with consumption of the media item in accordance with various aspects and embodiments described herein;

FIG. 11 is a flow diagram of another example method for surfacing information about items mentioned or presented in media item in association with consumption of the media item in accordance with various aspects and embodiments described herein;

FIG. 12 is a schematic block diagram illustrating a suitable operating environment in accordance with various aspects and embodiments.

FIG. 13 is a schematic block diagram of a sample-computing environment in accordance with various aspects and embodiments.

### DETAILED DESCRIPTION

### Overview

The innovation is described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

By way of introduction, the subject matter described in this disclosure relates to systems and methods for presenting additional information to a user regarding an item associated with a video frame that may be of interest to the user as the user is playing or otherwise consuming the video. In an aspect, the additional information can be presented to the user in response to a received signal or request for information about one or more items associated with the video frame. For example, a user can pause the video, point to the video, or otherwise indicate an interest in a video frame or specific object in a video frame. In response to the received signal, an association component can retrieve additional information about items associated with the video frame or the object in the video frame and present the additional information to the user in the form of an item information card on the video screen.

In another aspect, the additional information can be presented to the user in and automatic fashion (e.g., without an active request by the user) in response to occurrence of an item in the video that is associated with additional information. According to this aspect, the additional information can appear as a dynamic overlay of information appearing at an area of a screen at which the video is played. The overlay of additional information disappear after a predetermined window of time (e.g., a time considered sufficient for reading the additional information) or a user can pause the video to read and/or interact with the additional information. In other aspects, the additional information can be presented to a user at an auxiliary device.

In an aspect, in order to associate additional information about items displayed or mentioned in a video, rather than manually analyzing the video and embedding metadata with the respective items in the video, the subject systems process closed caption files for the video (text version of the dialog) to identify interesting words or phrases mentioned in the text. For example, theses words or phrases of interest can include terms or combination of terms that are listed in a data store or a, relational graph based version of the data store, as being popular items of user interest. The user interest items can further be respectively associated with additional information. For example, the additional information can include a definition, a pronunciation, a map, a link to purchase an item and etc. These words of phrases can then be classified or characterized as user interest items and tagged in relation to what frame of a video they are mentioned in. Therefore, when a user indicates and interest in a particular reference point in a video (e.g., by pausing the video or pointing to the video), an analysis component can identify the items associated with the frame of video occurring near reference point. An association component can then retrieve additional information associated with the items and a presentation component can present the additional information to the user (e.g., in the form of an item information card displayed on the video screen or an auxiliary device).

It is to be appreciated that the subject media information surfacing systems are is not limited to the above features and functionalities. Moreover, numerous embodiments of systems for surfacing information about items mentioned or presented in a film are contemplated, and the respective embodiments can provide one or more these features or functions in any suitable combination.

### Example Systems for Surfacing Information about Items Mentioned or Presented in a Film in Association with Viewing the Film

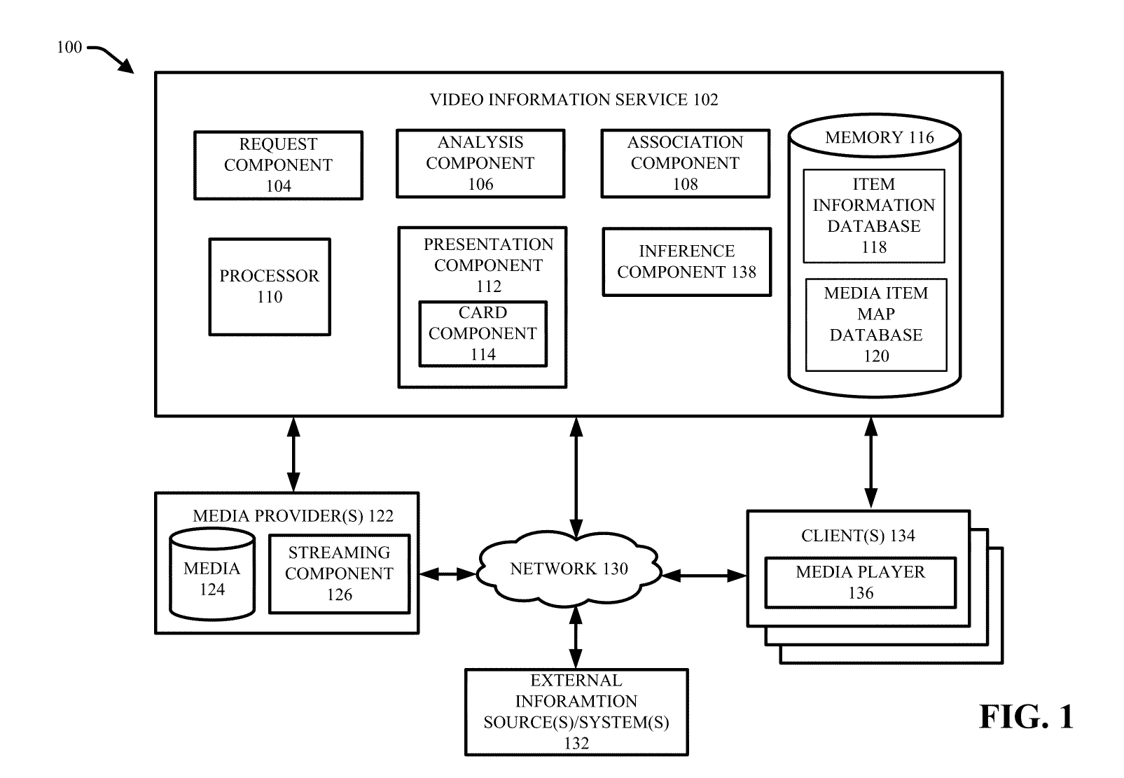

Referring now to the drawings, with reference initially to FIG. 1, presented is a system 100 configured to facilitate viewing videos and providing information about items mentioned or presented in the videos in association with viewing the videos. System 100 can include video information service 102, one or more media providers 122, one or more external information sources or external systems 132, and one or more clients 134. Aspects of systems, apparatuses or processes explained in this disclosure (e.g. video information service 102, media providers 122, external information sources or external systems 132, and clients 134), can constitute machine-executable components embodied within machine(s), e.g., embodied in one or more computer readable mediums (or media) associated with one or more machines. Such components, when executed by the one or more machines, e.g., computer(s), computing device(s), virtual machine(s), etc. can cause the machine(s) to perform the operations described.

Video information service 102 can include memory 116 for storing computer executable components and instructions. Video information service 102 can further include a processor 110 to facilitate operation of the instructions (e.g., computer executable components and instructions) by video information service. Although not depicted, in various aspects the one or more media providers 122, external information sources or external systems 132, and clients 134 can also respectively include memory for storing computer executable components and instructions and a processor to facilitate operation of the instructions.

The one or more media providers 122 are configured to provide media to one or more clients 134 over a network 130. As used herein, media refers to various types of multi-media, including but not limited to, video (e.g., television, movies, films, shows, music videos, and etc.), audio (e.g., music, spoken script, and etc.), and still images. In an aspect, a media provider 122 can include a media store that stores at least media 124 and a streaming media component 126 that streams media to a client 134 over a network 130. For example, a client 134 could access media provider 122 to receive a streamed video held in data store 124. In another aspect, a media provider 122 can access media located externally from the media provider 122 (e.g., at an external system 132) for streaming to a client device 134 via streaming component 126. Still in other aspects, a media provider 122 can provide downloadable media items, held locally in data store 124 or externally, to a client 124.

Video information service 120 is configured to process media, prior to being presented and/or while being presented to a user (e.g., via a client device 134), to identify items of potential user interest mentioned or presented in the media, and to associate additional information with the items. The video information service 102 is further configured to render the additional information to a user during the consumptions of the media. In an aspect, the additional information is rendered automatically in response to occurrence of an item in the media having additional information associated therewith. In another aspect, the additional information is rendered in response to an expressed or inferred user interest in an item, mentioned or presented in the media during consumption of the media. As a result, when a user views media, such as a video, and sees or hears an item of particular interest to the user, the user can request and receive additional information about the item of interest without conducting a manual search regarding the item.

In an aspect, video information service 102 processes media stored or otherwise provided by one or more media providers 122. For example, video information service 102 can process videos stored in media store 124. However, it should be appreciated that video information service 102 can perform various aspects of media processing and information rendering regardless of the source of the media.

A client 134 can include any suitable computing device associated with a user and configured to interact with video information service and/or a media provider 122. For example, a client device 134 can include a desktop computer, a laptop computer, a smart-phone, a tablet personal computer (PC), or a PDA. In an aspect, a client device 134 can include a media player 136 configured to play media. For example, media player 136 can include any suitable media player configured to play video, pause, video, rewind video, fast forward video, and otherwise facilitate user interaction with a video. As used in this disclosure, the terms “content consumer” or “user” refers to a person, entity, system, or combination thereof that employs system 100 (or additional systems described in this disclosure). In various aspects, a user employs video information service 102 and/or media providers via a client device 134.

In an aspect, one or more components of system 100 are configured to interact via a network 130. For example, in one embodiment, a client device 134 is configured to access video information service 102 and/or an external media provider 122 via network 130. Network 130 can include but is not limited to a cellular network, a wide area network (WAD, e.g., the Internet), a local area network (LAN), or a personal area network (PAN). For example, a client 134 can communicate with a media provider 122 and/or video information service 102 (and vice versa) using virtually any desired wired or wireless technology, including, for example, cellular, WAN, wireless fidelity (Wi-Fi), Wi-Max, WLAN, and etc. In an aspect, one or more components of system 100 are configured to interact via disparate networks. For example, client 130 can receive media from a media provider 122 over a LAN while video information service can communicate with a media provider 122 over a WAN.

In an embodiment, video information service 102, media provider 122 and the one or more clients 134 are disparate computing entities that are part of a distributed computing infrastructure. According to this embodiment, one or more media providers 122 and/or clients 134 can employ video information service via a network 130. For example, video information service 102 can access a media provider via network 130, analyze media provided to a client by the media provider 122 over the network 130 and render additional information regarding the media to the client 134 over the network 130. In other embodiments, one or more components of video information service 102, media provider 122 and client 134 can be combined into a single computing entity. For example, a media provider 122 can include video information service 102 (and vice versa), such that media provider 122 and the video information service 102 together operate with a client 134 in a server client relationship. In another aspect, a client 134 can include video information service 102. Still in yet another aspect, the components of video information service 102 can be distributed between a client 134 and the video information service. For example, a client could include one or more of the components of video information service 102.

In order to facilitate various media analysis and information rendering operations, video information service 102 can include request component 104, analysis component 106, association component 108, presentation component 112 and inference component 138. Stored in memory 116, video information service 102 can also include item information database 118 and video item map database 120.

In an aspect, the analysis component 106 is configured to analyze media (e.g., videos, music, pictures) and identify one or more items in the media that could be of potential interest to a user. In particular, the analysis component 106 can analyze a video to identify persons, places, or things, presented or mentioned in the video that a user may desire to know additional information about. For example, an actor may mention a city that a viewer would like to know more about or wear a watch that the viewer would like to explore purchasing. The analysis component 106 is configured to analyze the video to identify items, such as the city and the watch, that a viewer finds interesting. Such items are referred to herein as items having an inferred or determined user interest value or user interest items. After the analysis component 106 has identified one or more user interest items in media, the association component 108 can associate additional information (e.g., definitions, background information, purchasing links, and etc.) with the one or more user interest items. The presentation component 112 can further provide the additional information to a user (e.g. at a client device 134) when the user consumes the media, either automatically in response to occurrence of the items or in response to a received signal indicating an interest in an area or frame of the media having one or more user interest items associated therewith.

In an aspect, the analysis component 106 can analyze a media item to identify user interest items presented or mentioned therein, prior to viewing/playing of the media item at a client device 134. For example, the analysis component 106 can analyze videos stored in media database 124 and identify user interest items found therein. The association component 108 can them map additional information to the user interest items and/or embed or otherwise associated metadata with the user interest items that relates to additional information about the user interest items.

In another aspect, the analysis component 106 can perform analysis of a media item to identify user interest items presented or mentioned therein in response to a signal or request received from a user during the consumption of the media item (e.g., during playback of the media item). The signal includes a request for additional information about one or more items mentioned or presented in the media item as interpreted by the request component 104, discussed infra. In an aspect, such a request can include information indicating one or more particular objects/items of interest to the user and/or one or more frames or segments of the media item that include one or more objects/items of interest to the user. According to this aspect, the analysis component 106 can analyze the media item in response to the request, in substantially real time as the request is received, to identify one or more user interest items in the media item related to the request. For example, as a user is viewing a video, the user can pause the video at a particular time point (e.g., 1:14:01). The pausing of the video can be interpreted (e.g., by request component 104 and/or analysis component 106) as a request for additional information about one or more items mentioned or presented in the video at or around the pause point (e.g., 1:14:01). The analysis component 106 can then analyze the portion of the video at or around pause point to identify user interest items mentioned or presented therein.

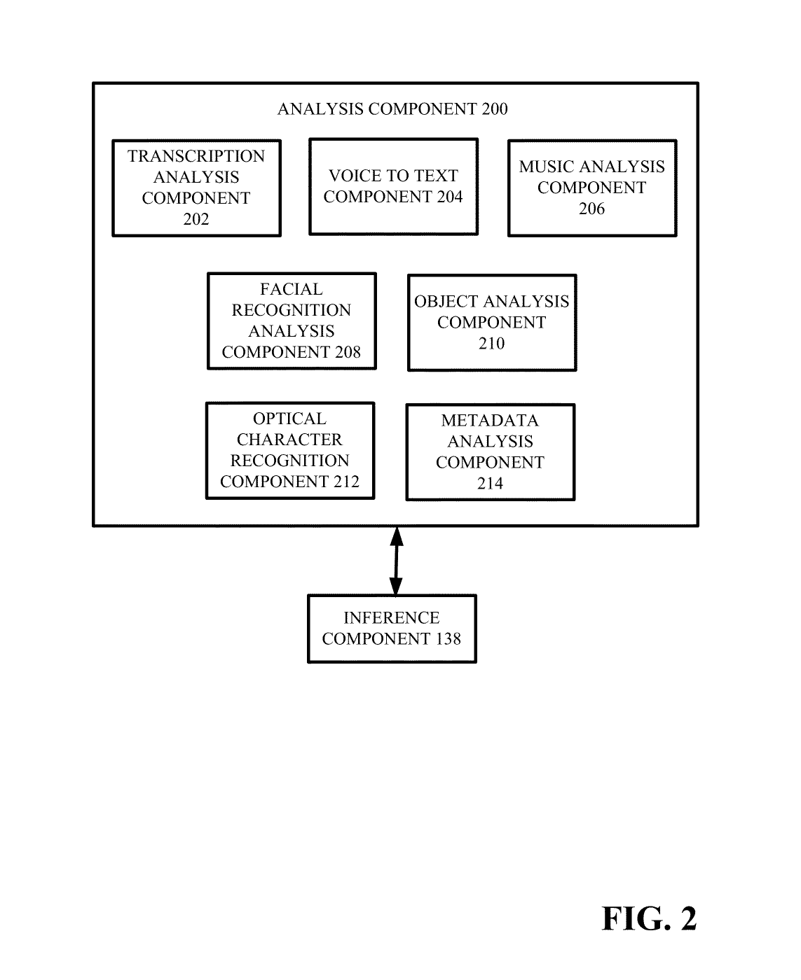

In an embodiment, the analysis component 106 analyzes transcriptions (e.g., text versions of the audio portion of a media item) of media items to identify words or phrases in the transcription that are considered user interest items. For example, the analysis component 106 can analyze closed-captioned files for videos to identify words or phrases representative of user interest items. As described herein, analysis of media by analysis component 106 includes analyses of a transcription file associated with the media. According to this embodiment, text versions of audio of media items can be stored as transcription files in media store 124 in association with the actual media item and/or or otherwise accessible to video information service 102 at an external information system/source 132 via a network 130. The various mechanisms by which the analysis component 106 analyzes a media item to identify user interest items are discussed in greater detail greater detail with respect to FIG. 2.

The association component 108 is configured to relate associate user interest items with additional information and map user interest items to segments/frames in a media item in which they occur. In some aspects, where the analysis component 106 is configured to perform image analysis (e.g., object and person analysis discussed infra), the association component 108 can also associate user interest items with screen coordinates at which the items appear with respect to a segment/frame of a video. Associative information (e.g., information indicating frames or coordinate points in a video where a user interest item occurs and/or additional information about the user interest item) generated by the association component 108 can further be stored in memory 112. For example, the associative information can be stored in memory 112 as a video information map, chart or look-up table.

In an aspect, after the analysis component 106 identifies user interest items in a video, the association component 108 can associate the identified user interest items to segments or frames and/or screen coordinates in the video where the user interest items are presented or mentioned. According to aspect, the association component 108 can generate a video item information map that maps user interest items for the video to segments and/or screen coordinates with respect to the segments. The video item information map can further be stored in media item map database 120. Such mapping of user interest items to video segments and/or coordinates can be performed by video information service prior to consumption of the video. For example, an actor could speak of the city Munich at point 00:32:01 or during frames 18 and 19. According to this example, the association component 108 can map the user interest item “Munich” to point 00:32:01 or frames 18 and 19 of the video.

In another aspect, the association component 108 can also locate or find additional information for user interest items and link the additional information to the user interest items. In an aspect, the association component 108 can query various internal (e.g., item information database 118) and/or external (e.g., external information sources/systems 132) data sources to find additional information about a user interest item. For example, where the user interest item is a city, the association component 108 can find information defining where the city is located, the population of the city, attributes of the city and a map illustrating the location of the city. In another example, where the user interest item is an event such as a sports match, the association component 108 could find information defining the time and place of the sports match, the players in the match, the score of the match, and key new pieces related to the match.

In an aspect, the association component 108 queries item information database 118 stored in memory 116 to find such additional information about user interest items. According to this aspect, item information database 118 can store additional information about a plurality of known items that could be considered user interest items. For example, the item information database 118 could resemble a computer based encyclopedia that provides a comprehensive reference work containing information on a wide range of subjects or on numerous aspects of a particular field. In other aspects, the association component 108 can query various external information sources or systems 132 that can be accessed via a network 130 to find information on user interest items. For example, the association component 108 could query an online shopping website to find purchase information about a object that is considered a user interest item.

It should be appreciated that the type and details of additional information gathered by the association component 108 for a particular user interest item can vary. In an aspect, additional information to be associated with user interest items is predetermined and defined by the information associated with known items in item information database 118. In other aspects, the association component 108 can apply various algorithms and inferences to pick and choose the type of additional information to associate with a user interest item. For example, the association component 108 can search several databases of information to find additional information about a user interest item that is most relevant to a user and a current point in time. In another example, the association component 108 can employ algorithms that define the type of additional information to associate with user interest items based on the type of item or category in which the item falls (e.g., a location, an object, a quote, an event, person, a song, a material object). According to this example, the association component 108 can apply predetermined criteria, as defined in memory 116, that defines what type of additional information is to be associated with a user interest item based on the item type/category (e.g., item is a city: include state and country, include directions map, include information about population; item is a song: include title, artist, data released, and chart data; item is a car: include make, model, date released, and purchase information; and etc.)

In an embodiment, the association component 108 can link additional information to user interest items presented or mentioned in a media item information map information map stored in media item map database 120. For example, a video item/media item information map can include information mapping one or more of: user interest items to video segments, user interest items to screen coordinates with respect to video segments, and information mapping user interest items to additional information about the respective user interest items. According to this aspect, after the association component 108 finds additional information about a user interest item in a particular video, the association component 108 can store information mapping the user interest item for the particular video to the additional information in media item data store 120. In an aspect, the media item information map can map user interest items for media to additional information where the additional information is stored elsewhere (e.g. item information database 118 and/or one or more external information sources/systems 132). In another aspect, the media item information map can map user interest items for media to additional information where the additional information is also stored with the media item information map in media item map database 120.

In an aspect, the media item map data store 120 includes pre-configured information mapping user interest items to video segments, coordinates and additional information for a large number of videos available to a client (e.g., thousands to millions). According to this embodiment, when a client accesses a video, the video information service 102 can quickly identify user interest items and provide a user with the additional information linked thereto, in response to a user request. In an aspect, a client 134 can receive a video as streaming media from a media provider 122 over a network 130. According to this aspect, when the user requests additional information about one or more user interest items, the video information service 102 can quickly retrieve the additional information using the media item map database 120.

In another aspect, a client 134 can download a media item from a media provider 122 for local viewing. According to this aspect, the association component 108 can generate a local file (e.g., a local video item information map) for the downloaded media item from media item map database 120 that includes information mapping user interest items to segments and additional information. (According to this aspect, the local file can include the additional information for each of the user interest items for the downloaded media item). The client 134 can further include a local version of the video information service 102, (e.g., having one or more components of the video information service 102) to locally process user requests for additional information about a user interest item and present the additional information to the user in response to the request, using the downloaded local file. According to this aspect, a client 134 can view a video and receive additional information about items in the video without being connected to a network 130.

In some aspects, media item data store 120 can serve a cache that is populated with information in association with consumption of the media item. The information can include information that maps user interest items to respective video segments in which they occur and to additional information for the respective user interest items. For example, as a media provider 122 begins to stream a video to a client 134, the video information service 102 can initiate processing of the video to identify potential user interest items and associate the user interest items with video segments, coordinates/segments, and additional information about the respective user interest items. The user interest items and additional information can be stored in media item map database 120 where the database serves as cache. Accordingly, if and when a user requests additional information about one or more user interest items mentioned or presented in the video, the video information service 102 can quickly access the requested information in the media item map database 120. The cache can later be cleared after the video is completed. According to this aspect, the video information service 102 can apply pre-processing of media in anticipation of user requests at the time a video is accessed by a client.

In another embodiment, the analysis component 106 can identify user interest items in media at the time of a user request for additional information related to a segment of the media item. According to this aspect, the association component 108 can also associate additional information with the identified user interest items for the segment at the time of the request. Therefore, rather than pre-processing the entire video and storing information mapping user interest items to segments in which they occur and additional information for the respective user interest items, video information service 102 can perform processing of the particular segment alone, at the time of a user request. The presentation component 112 can present additional information for the identified user interest items related to the video segment after identification of the user interest items by the analysis component and retrieval of the additional information by the association component 108.

It should be appreciated that video information service 102 can process any suitable number N (where N is an integer) of media items prior to consumption in order to generate data mapping user interest items to segments, coordinates, and/or additional information and store the data in media item data store 120. Further, any processing of media items by video information service 102 (e.g., user interest item identification, association of additional information with the user interest items, and card generation for the user interest items), can be stored in memory 116 for later use/re-use.

It should be appreciated that although item information database 118 and video item map database 120 are included within video information service 102, item information database 118 and/or video map database 120 can be external from video information service 102. For example, item information database 118 and/or video map database 120 can be centralized, either remotely or locally cached, or distributed, potentially across multiple devices and/or schemas. Furthermore, item information database 118 and/or video map database 120 can be embodied as substantially any type of memory, including but not limited to volatile or non-volatile, solid state, sequential access, structured access, random access and so on.

Request component 104 is configured to monitor user consumption of a media item (e.g., playing of a video) to identify a user indication of one or more items in the media item that are of interest to the user. For example, the request component 104 can monitor where a user pauses a video and identify a section of the video associated with the point at which the video is paused as including one or more items of interest to the user. In another example, the request component 104 can receive a voice command during the playback of a video that voices an interest in a particular item appearing in the video. As used herein, such user indication of interest in an object of a video and/or one or more frames/sections of a video are considered requests for additional information about the object and/or items presented or mentioned in the frames. As used herein, an object can include a person, place or thing.

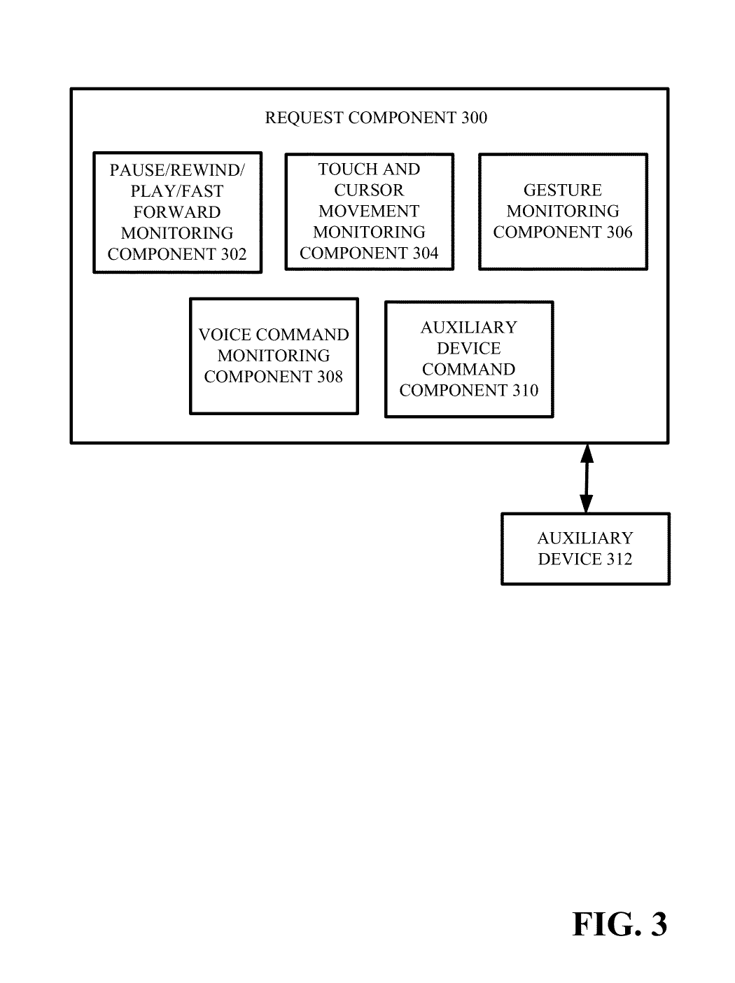

For example, a user can view a video (e.g., being played on a client device 134 streamed from a media provider) and point to, move a cursor over, or otherwise indicate an interest in a particular object in the video. In another example, a user can view a video and pause the video after seeing an object of interest, hearing an actor speak of something of interest, and/or hearing a soundtrack/music of interest. The point where the video is paused can further be interpreted by the request component 104 as associated with one or more video segment of interest containing one or more items of interest to the user. According to these examples, the request component 104 is configured to track these user indicated object/video segment interests and interpret these user indicated object/video segment interests as requests for additional information about the object of interest and/or items associated with the segment of interest. The various mechanisms by which the request component 104 can track such user indications of interest in one or more items in a video and/or one or more frames of video that are associated with one or more items of potential user interest are described in greater detail with reference to FIG. 3.

In addition to analyzing a video to identify user interest items occurring therein, the analysis component 106 is further configured to analyze user requests for additional information received by the request component 104 to determine or infer one or more user inters items associated with the request. The manner in which the analysis component 106 determines or infers user interest items associated with a request depends at least on the format of the request. As discussed in greater detail with respect to FIG. 3, the request component 104 can interpret various user actions/commands as requests for additional information about one or more items in a video.

For example, when a user pauses a video, the request component 104 interprets the pausing event as a request for additional information associated with user interest items occurring in the video at or near the point where the video is paused. According to this aspect, the analysis component 106 can analyze the request by determining or inferring a section or frame(s) of the video associated with the pausing event. The analysis component 104 can apply various algorithms or look-up tables defined in memory 116 to facilitate identifying a section of video associated with the pausing event. For example, the analysis component 106 can apply a rule whereby the section associated with a pausing event that likely includes one or more items of interest to a user includes the window of X seconds before the pausing event and Y seconds after the pausing event (where X and Y are variable integers). According to this example, X could be defined as 5 seconds and Y could be defined as 3 seconds. In an aspect, once the analysis component 106 identifies a section of frame associated with a pausing event, the analysis component 106 can employ information in media item map database 120 mapping the section to one or more user interest items previously determined to be mentioned or presented in that section.

In another example, a user could place a cursor over an object of interest appearing on a video screen, touch the object on the video screen and/or point to an object on the video screen. The request component 104 can interpret such user actions as requests for additional information about the targeted object. The analysis component 106 can further analyze the request to identify the targeted user interest object. For example, the analysis component 106 can identify the point in the video associated with the request (e.g., user pointed/touched video object at frame 14) and employ information in media item map database 120 mapping the section of the video associated with the request to one or more user interest items previously determined to be mentioned or presented in that section. For example, the analysis component 106 can determine that item numbers 104, 823 and 444 are associated with frame 14 associated with a user request.

The analysis component 106 can further employ additional techniques to identify a specific object associated with a user request when the user request involves information related to pointing to/touching or otherwise targeting a specific object. For example, the analysis component 108 can also employ pattern recognition software to determine or infer objects present in the video at or near a point where the user placed a cursor/touched or pointed to the screen. Further, the analysis component 106 can employ information previously determined in media item map database that maps user interest objects presented at respective frames of a video to areas of a display screen. For example, such information could indicate that graphical coordinate position (−2, 16) at point 0:46:18 in video ID number 16,901 includes user interest item 823 (where numbers for coordinate −2, 16, point 0:46:18 and video ID number 16,901 are variables).

Still in yet another aspect, in order to express interest in a particular object mentioned or presented in a media item, a user could voice his or her request. For example, a user could speak “tell me more about Tom's watch,” at a point in a video where the user sees actor Tom wearing an interesting watch. According to this aspect, the analysis component 106 can employ information mapping the section of the video associated with the request (e.g., in media item map database 120) to user interest items included in the section and/or speech analysis software to identify the user interest item associated with the request.

After the analysis component 106 identifies one or more user interest items associated with a user request, and after the association component 108 associates additional information with the one or more user interest items, the presentation component 112 presents the additional information about the one or more user interest items to a user. The additional information can include text, images, audio and/or video. The presentation component 112 can employ various mechanisms to present additional information about user interest items to a user. In an aspect, the additional information can be provided to a user at the client device used to play the media item associated with the user request and/or an auxiliary client device employed by the user.

In some aspects, the additional information can be presented to multiple devices at a time. For example, in addition to a local client device receiving and viewing additional information about items in a streaming video, a networked device can receive data indicating user interest items that a particular client device is viewing in real time. The networked device can further gather data from a plurality of client devices (e.g., thousands to millions) to track and analyze user interest in various items of various videos. The networked device can therefore employ crowd sourcing techniques to identify trending user interest items.

In one embodiment, the presentation component 112 can be configured to present additional information about user interest items in response to user requests. However, in another embodiment, the presentation component 112 can present additional information about user interest items in an automatic fashion in response to occurrence of the items during the playing of the video in which the occur and/or in response to a user request. In an aspect, a user can opt to receive continuous information about user interest items during the playing of a video. For example, in a manner similar to selecting a preferred language to view a video, or selecting an option to have closed captioned information presented during the playing of a video, a user can select to receive additional information about user interest items as they appear in a video. In an aspect, the user can further specify how to display the additional information (e.g., as an information stream on the screen at which the video is played or at an auxiliary device). In another aspect, a user can specify particular user interest items to receive information about. For example, a user can select categories of items he or she desires to receive additional information about (e.g., “show me additional info. about actors,” “show me additional info. about music,” and etc). According to this aspect, a user can restrict the type of user interest items for which additional information is presented.

In an aspect, the presentation component 112 includes a card component 114 that generates an information card that includes the additional information in the form of text and/or images in a dialogue box. The information card be overlayed on the display screen at which a media item (associated with the user interest items) is being displayed (e.g., paused or played) and/or presented at an auxiliary device. In an aspect, the information card can allow a user to select one or more items on the card, (such as a word, a link, or an image) to obtain additional information about the one or more items. For example, the information card can present the user with a tool kit of selection options and interactive tools related to exploring and consuming the additional information. In another aspect, the presentation component 112 can display the additional information as a toolbar or menu appearing below a display screen at which a media item associated with a user request is displayed. Still in yet another aspect, the presentation component 112 can present the additional information as an overlay dialogue box adjacent to the user interest item where the user interest item appears on the displays screen as a still image (e.g., where a video is paused and the user interest item is displayed).

In some aspects, the presentation component 112 can present an icon or data object that a user can select to retrieve an information card (or additional information in another format). For example, the presentation component can present a star, question mark, or other type of data object on display screen at which a video is being played where a user interest item occurs (either automatically or in response to a user request). The user can the select the icon to retrieve the data card. In an aspect, the icon can relate to the type of user interest item that it represents (e.g., where the user interest item is a song, the icon can include music notes, where the user interest item is a person, the icon can include a silhouette of a face, where the user interest item is a place, the icon can include a globe, and etc.).

Video information service 102 can further include inference component 138 that can provide for or aid in various inferences or determinations. For example, all or portions of request component 104, analysis component 106, association component 108, presentation component and/or memory 116 (as well as other components described herein) can be operatively coupled to inference component 138. Additionally or alternatively, all or portions of inference component 138 can be included in one or more components described herein. Moreover, inference component 138 may be granted access to all or portions of media providers 122, external information sources/systems and clients 134.

Inference component 138 can facilitate the analysis component when identifying user interest items in a video and when identifying one or more user interest items a user is interested in while consuming the video in response to a request. In order to provide for or aid in the numerous inferences described herein (e.g., inferring information associated with a user request for additional information about one or more user interest items, inferring user interest items associated with a media items, inferring one or more user interest items associated with a user request, inferring additional information to associate with user interest items, and etc), inference component 138 can examine the entirety or a subset of the data to which it is granted access and can provide for reasoning about or infer states of the system, environment, etc. from a set of observations as captured via events and/or data. An inference can be employed to identify a specific context or action, or can generate a probability distribution over states, for example. The inference can be probabilistic—that is, the computation of a probability distribution over states of interest based on a consideration of data and events. An inference can also refer to techniques employed for composing higher-level events from a set of events and/or data.

Such an inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority

Referring now to FIG. 2, presented is an example embodiment of an analysis component 200 in accordance with various aspects described herein. Analysis component 200 can include the various features and functionalities described with reference to analysis component 106. Analysis component 200 can be employed by various systems and component described herein (e.g., systems 100, 400, 500 and related components). Repetitive description of like elements employed in respective embodiments of systems and interfaces described herein are omitted for sake of brevity.

Analysis component 200 can be employed by video information service 102 to identify user interest items presented or mentioned in a media item, such as a video. In an aspect, the analysis component 200 is employed by a video information service 102 to identify user interest items presented or mentioned in a video prior to consumption of the video. The analysis component 108 can employ various mechanisms and tools to identify user interest items presented or mentioned in a video prior to consumption of the video. In an aspect, the analysis component can employ one or more of transcription analysis component 202, voice to text component 204, music analysis component 206, facial recognition analysis component 208, object analysis component 210, optical character analysis component 212, metadata analysis component and inference component 138 to facilitate identifying user interest items presented or mentioned in a video prior, to consumption of the video. According to this aspect, as discussed supra, the association component 108 can map such user interest items identified by the analysis component 200 to the frames of the video in which they occur and/or the coordinates on a video screen in which the user interest items occur during a particular frame, prior to consumption of the video by a user (e.g., prior to playing of the video). The association component 108 can further associate additional information with the user interest items prior to consumption of the video or at the time of a user request for such additional information.

In another aspect, the analysis component 200 can be employed by video information service 102 to identify one or more user interest items associated with a user request to learn additional information about the one or more user interest items in association with playback of a media item including the one or more user interest items. According to this aspect, the analysis component 200 can employ information previously determined (e.g., information in media item map database 120) that maps user interest items for a video to the frames of the video in which they occur and/or the coordinates on a video screen in which the user interest items occur during a particular frame to facilitate identifying user interest items associated with a user request. The association component 108 can then find additional information about the user interest items associated with the user request (using media item map database 120 or item information database 118 having the additional information previously mapped to the respective user interest items or using various internal or external data sources to gather the additional information) and the presentation component 112 can present the additional information to the user.

In an aspect, when identifying one or more user interest items associated with a user request, the analysis component 200 can also employ one or more of transcription analysis component 202, voice to text component 204, music analysis component 206, facial recognition analysis component 208, object analysis component 210, optical character recognition component, metadata analysis component 214 and inference component 138 to facilitate identifying user interest items. For example, the analysis component 200 can employ previously determined information mapping user interest items for a video to the frames of the video in which they occur and/or the coordinates on a video screen in which the user interest items occur during a particular frame to facilitate identifying user interest items associated with a user request as well as analysis techniques afforded by one or more component 202-210 and 138 to identify user interest items associated with a request. For example, the analysis component 200 could use previously determined information that maps a section of a video to one or more user interest items associated with that section as well as pattern recognition analysis techniques afforded by the object analysis component 210 to identify a particular user interest object associated with a request.

In an embodiment, the analysis component 200 is employed by a video information service 102 to identify user interest items associated with a request without performance of any pre-processing of the video. According to this embodiment, rather than identifying user interest items in the video and mapping them to respective sections of the video prior to use consumption, the analysis component 200 can perform all video processing analysis in response to a user request. For example, a user request could indicate interest in frame 19 of a video. The analysis component 200 can then analyze frame 19 of the video (using components 202-210 and/or 138) to identify user interest items affiliated with frame 19. After the items are identified, the association component 108 can associate additional information with the identified items and the presentation component 112 can present the additional information. According to this embodiment, all processing related to identifying user interest items and associating additional information with the identified user interest items can be performed in real time or substantially real time as the user request.

Transcription analysis component 202 is configured identify user interest items mentioned in a media item. In particular, transcription analysis component 202 can analyze a transcription file of the audio portion of a media item to identify words or phrases that represent items of user interest. Transcription files can be associated with any media item having an audio component, (e.g., music, video, book on tape, and etc). According to this aspect, a transcription file of the audio portion of a media item is considered to be in-time or substantially in-time with the actual audio of the media item (e.g., text versions of the words that are spoken by an actor/narrator of a film are mapped to the timing in the film in which they are spoken). In an aspect, a transcription file can include a closed captioned file of text that is associated with a video. For example, many videos are recorded and formatted with closed-captioned files associated therewith that include text versions of the words spoken by actors or narrators of the video matched with the actual timing in the video when the words are spoken. Often times, such closed captioned files are displayed simultaneously with the video to assist the hearing impaired so that they can read the dialogue as it is spoken during a video.

In an aspect, the transcription analysis component 202 can identify words or phrases that represent items of user interest in a transcription file. The transcription analysis component 202 can further determine or infer that the time of occurrence of the word or phrase in the transcription file correlates to the time of occurrence of the word or phrase in the actual video. For example, where the transcription analysis component identifies a word or phrase at point 1:31:02 in a transcription file, the analysis component can determine that the word or phrase occurs at substantially point 1:31:02 in the actual video. The transcription analysis component can further associate the word or phrase with the frame or section of video occurring at or around point 1:31:02 (e.g., plus or minus a few seconds).

Because the transcription analysis component 202 can relate user interest words in a transcription file to points or frames/sections of a video in which they occur, the association component 108 can associate the user interest items, (as represented in words or phrase found in a transcription file), with the point or frame/section of a video in which they occur in media item database 120. The analysis component 200 can then employ such a mapping when later identifying user interest items associated with a user request where the user request is associated with a point or frame/section of a video. Also, the transcription analysis component 202 can identify words or phrases that represent user interest items occurring at a place in a transcription file that corresponds to a point in a video associated with a user request (e.g., where the analysis component 200 does not pre-process videos to map terms to frames).

The transcription analysis component 202 can employ various techniques to identify or extract words or phrases in a transcription file that it considers having a user interest value. In an aspect, the analysis component 202 can employ one or more filters that filters words or phrases in a transcription file to removes words as a function of type. For example, the transcription analysis component 202 could filter out all articles as having no user interest value. In another example, the transcription analysis component 202 could filter out all words aside from nouns and/or verbs. In another aspect, the transcription analysis component 202 can apply one or more filters that facilitate identifying words having user interest value as a function of character length (e.g., words having three characters or less can be filtered out).

In another aspect, the transcription analysis component 202 can query words or phrases present in a transcription file against a database of known terms having a predetermined user interest value. The transcription analysis component 202 can then determine that all words or phrases that appear in a transcription file and that have also been predetermined to have a user interest value, as defined in the known database, as being user interest items. For example, item information database 118 can include a list of predetermined user interest items that the transcription analysis component can compare with a transcription file to identify user interest items described in the transcription file. In some aspects, the analysis component can consider words or phrases that are not identical but substantially similar in nature with known user interest items as qualifying as a user interest item. For example, the transcription analysis component 202 can consider the word discotheque in a transcription file as synonymous with the terms club or nightclub appearing in a known database and therefore consider the word discotheque as representative of a user interest item.

Voice to text component 204 can be employed by analysis component 200 to generate a transcription file for a media item if one has not been previously generated for a media item and/or is not accessible to video information service 102. In another aspect, voice to text component 204 can interpret received user voice commands. For example, where user states “What kind of watch is that?,” the voice to text component can convert the speech to text. The analysis component 200 can then analyze the words in the user request to facilitate identifying a user interest item that is of interest to the user. For example, the analysis component 200 could extract the word “watch” from the command and use the word in association with other information (e.g., frame associated with the request) to identify the particular item of interest to the user. Voice to text component 204 can employ known software that can receive audio, analyze the audio, and output text representative of the audio.

Music analysis component 206 is configured to analyze a media item to identify music associated with a media item and to associate the music with sections/frames of the media item (e.g., video) in which they occur. According to this aspect, the music occurring in a video can constitute a user interest item. For example, the music analysis component 206 can identify songs occurring in a video, where they occur in the video, and the association component 108 can find additional information about the song (e.g., title, artist, release data and etc.). According to this aspect, a user can pause a video at or around a point in the video where a song occurs. In an aspect, the analysis component 200 can determine that the item of interest to the user, based on the pausing event, is a song played at or near the point where the video was paused. For example, the music analysis component 206 could examine media item map database 120 to determine that song “ABC” has been previously mapped to the section of the video associated with the pausing event (e.g., via association component 108). In another example, the music analysis component 206 can analyze the section of the video associated with the pausing event at the time of the pausing event to identify music user interest items occurring therein. The association component 108 could then identify additional information about the song.

The music analysis component 206 can employ various known musical analysis techniques to identify music associated with a media item. For example, the music analysis component 206 can employ audio fingerprinting techniques whereby unique acoustic fingerprint data is extracted from an audio sample and applied to a reference database (e.g., stored in memory 116 or otherwise accessible to item information service 102) that relates the acoustic fingerprint data to a song title.

Facial recognition analysis component 208, is configured to analyze a media item to identify people associated with a media item and to associate the people with sections/frames of the media item (e.g., video) in which they occur. According to this aspect, a person occurring in a video can constitute a user interest item. In an aspect, the facial recognition analysis component 208 can further locate a coordinate of a video screen in which a face/person is located at a particular point in the video. For example, the facial recognition analysis component 208 can identify faces occurring in a video and where they occur in the video (e.g., video frame and video screen coordinates) and the association component 108 can find additional information about the person behind the face (e.g., the name of the actor, the age of the actor, other films that have featured the actor and etc). According to this aspect, a user can pause a video at or around a point in the video where a person appears occurs. In an aspect, the facial recognition component 208 can determine that the item of interest to the user, based on the pausing event, is a person that appeared at or near the point where the video was paused. For example, the facial recognition analysis component 208 could examine media item map database 120 to determine that person “John Smith” has been previously mapped to the section of the video associated with the pausing event (e.g., via association component 108). In an another example, the facial recognition analysis component 208 can analyze the section of the video associated with the pausing event at the time of the pausing event to identify one or more persons as potential user interest items occurring therein. The association component 108 could then identify additional information about the one or more persons.

The facial recognition analysis component 208 can employ various known facial recognition analysis techniques to identify people associated with a media item. For example, the facial recognition analysis component 208 can employ pattern recognition software that analyzes facial features to identify unique patterns based on the facial features and applies those unique patterns to a reference database (e.g., stored in memory 116 or otherwise accessible to item information service 102) that relates the unique patterns to identifications of people.

Object analysis component 210, is configured to analyze a media item to identify objects other than people (e.g., material objects depicted on screen) associated with a media item and to associate the objects with sections/frames of the media item (e.g., video) in which they occur. According to this aspect, an object occurring in a video can constitute a user interest item. In an aspect, the object analysis component 210 can further locate a coordinate of a video screen in which the object is located at a particular point in the video. The association component 108 can then associate the object with a frame of video in which it occurs as well a coordinate of the position of the object in the frame.

For example, the object analysis component 210 can identify objects occurring in a video and where they occur in the video, and the association component 108 can find additional information about the objects (e.g., what the object is, where to purchase the object, how much it costs and etc.). According to this aspect, a user can pause a video at or around a point in the video where an interesting object occurs. In an aspect, the object analysis component 210 can determine that the item of interest to the user, based on the pausing event, is the interesting object “Red Ball” that appeared at or near the point where the video was paused. For example, the object analysis component 210 could examine media item map database 120 to determine that object “Red Ball” has been previously mapped to the section of the video associated with the pausing event (e.g., via association component 108). In an another example, the object analysis component 210 could analyze the section of the video associated with the pausing event at the time of the pausing event to identify one or more objects as potential user interest items occurring therein. The association component 108 could then identify additional information about the objects.

The object analysis component 210 can employ various known video analysis software techniques to identify objects associated with a media item. For example, the object analysis component 210 can employ pattern recognition software that analyzes colors, shapes and patterns present in media to identify patterns in the media. The software can then compare the patterns to a reference database (e.g., stored in memory 116 or otherwise accessible to item information service 102) that relates the patterns to objects.

Optical character recognition (OCR) component 212 is configured to employ character recognition techniques to identify characters present in a video image. The analysis component can then identify words or phrases formed with such characters and determine whether the words or phrases constitute user interest items (e.g., using a look up table, algorithm, or inference based classification technique). For example, the OCR component 212 can analyze video frames image by image to identify characters written on a sign, logo, building, t-shirt, and etc. According to this example, where a video scene includes a sign that says “Munich Train Station,” the OCR component 212 could identify the phrase and the analysis component could classify the word Munich, train or station and/or the phrase Munich Train Station, as user interest items.

The metadata analysis component 214 is configured to analyze metadata associated with a media item to facilitate identifying user interest items in the media item. According to this aspect, a video provided by a media provider can include various degrees and types of metadata embedded therein (or otherwise associated therewith) that can facilitate identifying user interest items in the video. For example, a video can include metadata tags that tag user interest items a video producer considers relevant to a user. In another example, metadata tags can be embedded in video that include various descriptors about an items. For example, the metadata tags can describe what the user interest item is, how often it appears, a frame at which the item appears, a coordinate location of a video screen at which the item appears, a duration of how many seconds the items appears in a frame, a brand of the item, a relative importance of the item with respect to other user interest items, and etc.

The analysis component 200 can further employ inference component 138 to infer user interest items present or mentioned in a media item or transcription file associated with the media item (prior to consumption of the media item or in association with a user request for additional information about one or more user interest items). In particular, inference component 138 can examine the entirety of information available to it regarding a video to infer user interest items present in the video, clearly identify the items in the context of the video, and to infer one or more specific items a user is interested in based on a request. For example, the inference component 138 can identify a user interest items based on inferred associations between words/items identified in an analyzed transcript, identified music, identified facial images, identified object, and embedded metadata. In an aspect, the inference component 138 can infer or determine contextual data relating to the semantic content of a video to facilitate accurately identifying user interest items with respect to the context in which they are employed in the video.

In particular, resolving a user interest item (e.g., from a word identified in a transcription) out of context, can be difficult. For example, where the transcription analysis component 202 identifies the word “Munich” as a user interest item, the association component may associate additional information with the user interest item relating to Munich, N. Dak. instead of Munich, Germany. The inference component 138 can facilitate inferring/determining the appropriate characterization of a user interest item in a video to avoid this misinterpretation. In an aspect, the inference component 138 can examine metadata and other determined or inferred cues associated with a video that facilitates placing the user interest item in an appropriate context. For example, metadata can define a setting of the video (e.g., Germany as opposed to the United States). In another example, the inference component 138 can infer based on various other user interest items or features identified in the video with respect to a scene of the video or the video in entirety (e.g., a language employed, other user interest items identified that are associated with Munich Germany such as “1972 Summer Olympics”) a context of the video or scene in the video. The inference component 138 can then infer an appropriate characterization of the user interest item based on the context.

In other aspects, as discussed infra, the inference component 138 can employ information regarding user preferences, user demographics, current trends, and user social associations to facilitate inferring items of user interest in a media item or transcription file for the media item. For example, the inference component 138 can employ information regarding items that are currently popular amongst a plurality of user or popular in the media in general to facilitate inferring user interest items present in a transcription file. Further, the inference component 138 can employ user feedback information to facilitate identifying and accurately characterizing user interest items.

Referring now to FIG. 3, presented is an example embodiment of a request component 300 in accordance with various aspects described herein. Request component 300 can include the various features and functionalities described with reference to request component 104. Request component 300 can be employed by various systems and component described herein (e.g., systems 100, 400, 500 and related components). Repetitive description of like elements employed in respective embodiments of systems and interfaces described herein are omitted for sake of brevity.

Request component 300 is configured to receive user requests for additional information about one or more user interest items presented or mentioned in a media item. In particular, request component 300 is configured to track user actions/interactions with a media item as it is consumed at a client device 134 that indicate an interest in one or more user interest items presented or mentioned therein. For example, the request component 300 can monitor user action that references a frame of a media item and interpret that user action as a request for additional information about one or more user interest items associated with the frame. In another example, the request component 300 can track user actions that target a particular user interest item presented in a frame (e.g., actions such as pointing to an item) and interpret those actions as requests for additional information about the targeted user interest item.

In an aspect, request component 300 can employ pause/rewind/play/fast forward (PRPFF) request component 302 to facilitate identifying a video frame/segment that a user shows interest in. The PRPFF request component can further associate such user interest in a video frame/segment as a request for additional information about one or more user interest items associated with the segment. In an aspect, the PRPFF component 302 can analyze user interactions with a video related to pausing, rewinding, playing and fast forwarding the video to determine or infer a frame or segment of interest to a user. For example, the PRPFF component can interpret a pausing event as an indication of user interest in a video frame occurring at or around the pausing event. In another example, the PRPFF component 302 can interpret rewinding a video and replaying a section of a video as an indication of user interest in the section of the video replayed. Similarly, the PRPFF component 302 can interpret fast forwarding to a section of a video as an indication of user inters in section of the video fast forwarded to.

In some aspects, the PRPFF component 302 can determine or infer the section/frame of a video that the user is interested (based on their pausing, rewinding, playing, and fast-forwarding activity) and inform the analysis component of the section. In another aspect, the PRPFF component 302 can provide information defining a user's pausing, rewinding, playing, and fast-forwarding activity to analysis component 200 and/or inference component 138 for determining or inferring, respectively, a section/frame of a video that the user is interested in.

In an aspect, request component 300 can employ touch and cursor movement (TCM) request component 304 to facilitate identifying a video frame/segment that a user shows interest in as well as a particular user interest item that the user is interested in. The TCM request component 304 can further associate such user interest in a video frame/segment and user interest item as a request for additional information about the user interest item.

In an aspect, the TCM request component 304 can track cursor movement to determine when a user moves a cursor about a video screen as a video is played or paused. For example the TCM request component can determine where (e.g., coordinate position) and when (e.g., point/frame in the video) the cursor comes to rest. Similar to cursor movement, the TCM request component 304 can track where and when a user touches a video screen as a video is played or paused (e.g., where the client device 134 includes touch screen technology).

The TCM request component 304 can further interpret the coordinate position and frame associated with cursor movement or user touch as a request for additional information associated with an object appearing in a video at the coordinate position and frame/point in the video when the cursor comes to rest or where/when the user touches a screen. The TCM request component 304 can then provide this information to the analysis component 200 for identification of the user interest item associated with the coordinate position and video frame. In some aspects, a user can press a select button in association with cursor movement to more definitively indicate an object at screen location and time frame that the user is interested in. Still in other aspects, a user can press a pause button in association with cursor movement to more definitively indicate an object at screen location and time frame that the user is interested in.

Gesture request component 306 is configured to interpret user gesture commands as signals indicating user interest in a frame of video and/or a user interest item. In particular, gesture request component 306 can interpret gestures such as certain hand signals directed towards a screen at which a video is played as indications of interest in a frame of video or user interest item appearing on the screen. For example, the gesture request component 306 can track when a user points to a screen and identify a coordinate of the screen associated with the pointing. The gesture request component 306 can also identify a section/frame of the video associated with the gesture command. The gesture request component 306 can then supply the coordinate and frame information to the analysis component 200 for identifying of a user interest item associated with the coordinate and frame information. According to this aspect, the client device at which a user plays a video can include one or more sensors to facilitate gesture monitoring and interpretation. For example, the client device at which a video is played can include gesture request component 306.

Voice command request component 308 is configured to track and interpret user voice commands declaring an interest in a user interest item that is mentioned or presented in a video as it is played. For example, where a user states “What kind of watch is that?,” the voice command request component 308 can receive the voice command and provide the voice command to the analysis component 200 for analysis thereof, and/or convert the speech to text and provide the text to the analysis component for analysis thereof.

In an aspect, a user can employ an auxiliary device 312 to request information about an item of interest in a video. According to this aspect, a user can use a remote or other type of computing device (e.g., handheld or stationary) to input commands. For example, a user can employ a remote or application installed on a smartphone that allows a user to enter commands requesting information about items mentioned or presented in a video. According to this example, the remote can include a button to “request more information about an item.” The user can select this button when they hear or see an object of interest and in response, additional information can be presented to the user on the screen or at an auxiliary device. In another example, an application installed on an auxiliary device can allow a user to enter search terms to facilitate signaling a particular item they are interest in. For example, as a user is watching a video, the user may see a car that they like. The user can employ the application to type the word “car.” The application can then format a search request to the request component 300 with the word car. In an aspect, the auxiliary device command component 310 can receive and interpret commands sent from an auxiliary device. For example, the auxiliary device command component 310 can analyze the request with the word “car” received in association with a particular frame in the video to determine the user is interested in the Audi A6 appearing in the video at that time.

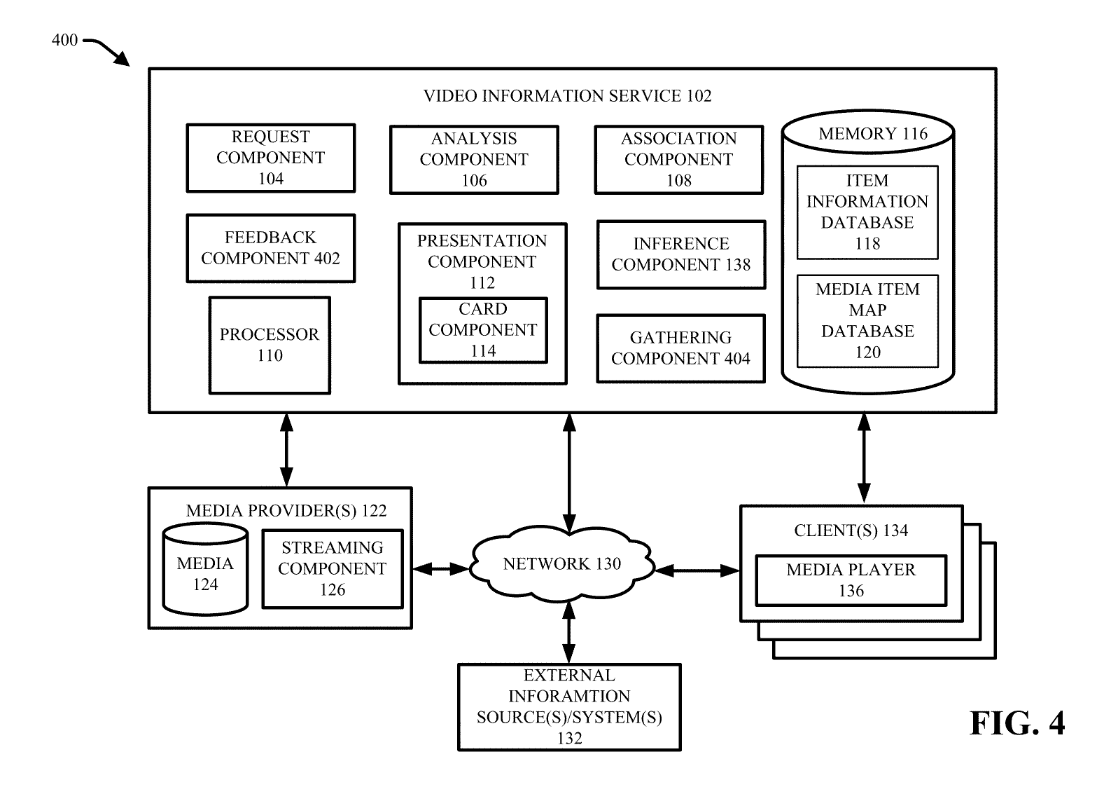

Turning now to FIG. 4, presented is another example embodiment of a system 400 for surfacing information about items mentioned or presented in a media item in association with consumption of the media item in accordance with various aspects described herein. System 400 is similar to system 100 with the exception of the addition of feedback component 402 and gathering component 404. Repetitive description of like elements employed in respective embodiments of systems and interfaces described herein are omitted for sake of brevity.

In an aspect, the presentation component 112 can present a user with additional information about a user interest item in the form of an interactive information card. In an aspect, this interactive information card can allow a user to select additional information options (e.g., a map or a link to a purchasing website) about the user interest item. In another aspect, this interactive information card can allow a user to provide feedback regarding the user interest item.

Feedback component 402 is configured to receive user feedback regarding a user interest item. This feedback can then be provided to analysis component 106 to facilitate determining whether the correct user interest item was identified by the analysis component 106 and/or memory 116 for future use by the analysis component 106 when identifying user interest items in a video. For example, an item information card can include an interface that asks a user whether an identified item is the item they are interested in. For example, a card could include a prompt stating “Are you interested in Munich Germany or Munich N. Dak.” The card can allow the user to select the appropriate option (e.g., using a remote, voice command, touch command and etc.). In another example, an information card can as a user whether an identified user interest item was correctly identified.

In another aspect, feedback component 402 can interject information gathering prompts during a video (e.g., on the video screen or at an auxiliary device) to facilitate learning information about the video from a user. In particular, the feedback component 402 can ask a user questions when the video information service 102 is unsure about user interest items occurring in a video. For example, the feedback can present a prompt that asks a user whether an actor is “Will Smith, yes or no.” The user can then answer the question, providing feedback to the feedback component 402 to be used by the analysis component when identifying the user interest item (e.g., the actor) and the association component 108 when associating the appropriate additional information with the user interest item.

In an aspect, the feedback component 402 can allow a user to offer feedback regarding user interest items in a video at his or her own discretion (e.g., without a prompt asking for user input). According to this aspect, as a user is watching a video, the user can touch the screen to identify user interest objects at the point of touch and/or voice an interpretation (e.g., speak a voice command) of an item the user sees or hears on the screen that the user considers interesting. This feedback can be used by the analysis component 106 when identifying user interest items for the user later in the video and/or when identifying user interest items in the video for a subsequent viewing (e.g., by the same user or another user).

Gathering component 404 is configured to gather additional information that can be employed by the analysis component 200 and/or inference component 138 when identifying user interest items in a media item in general or when identifying user interest items in a media item that the user has expressed an interest in association with a request. For example, the additional information can be employed by the analysis component 200 when determining or inferring items in a media item (e.g., based on words or phrases found in a transcription file for the media item, based on music identified, based on persons identified and based on objects identified) that should be characterized as user interest items, prior to consumption of the media item (e.g., for generating a media item information map). In another example, the additional information can be employed by the analysis component 200 when determining or inferring what one or more items a user is interested based on a user request indicating an interest in a segment of a video and/or an item of a video.

In an aspect, the additional information can include user profile information that includes information defining a user's preferences, interests, demographics and social affiliations. The profile information could be associated with video information service (e.g., in memory 116), a media provider 122, and/or an external system 132. According to this aspect, a user can grant video information service 102 access to one or more aspects of his or her profile information. The analysis component 106 and/or inference component 138 can employ a user's profile information to facilitate inferring items in a video that the user may be interested in.

In an example, profile information for a user “Jane Doe” could define her hobbies, her shopping preferences, her object interests, who her friends are, her location, and/or demographic information (e.g., age, occupation, sex, and etc.). For example, when Jane Doe pauses a video thus indicating an interest in a particular section of the video, the analysis component 106 can employ her profile information to facilitate inferring the particular item in the section that she is most likely interested in knowing more information about (e.g., where the section includes more than one user interest items associated therewith). In furtherance to this example, because Jane Doe enjoys collecting art, the analysis component or inference component 138 could infer that the artwork presented in the segment of the video is mostly likely the object that caught Jane's eye.

In another example, the gathering component 404 could gather information relating to trending items across a general population, trending items for a particular demographic or trending items for people in a user's social circle (e.g., as defined in profile information). For example, the gathering component 404 can employ crowd sourcing techniques and gather user feedback from a plurality of user regarding user interest items. This information can be collectively analyzed by the analysis component 106 and/or inference component 138 to accurately identify user interest items and/or to identify popular user interest items. The analysis component 106 and/or inference component 138 can also employ a user's profile information to facilitate inferring items in a video that the user may be interested in knowing more information about. In yet another example, additional information can include information relating to a particular user's purchasing history or media viewing history.

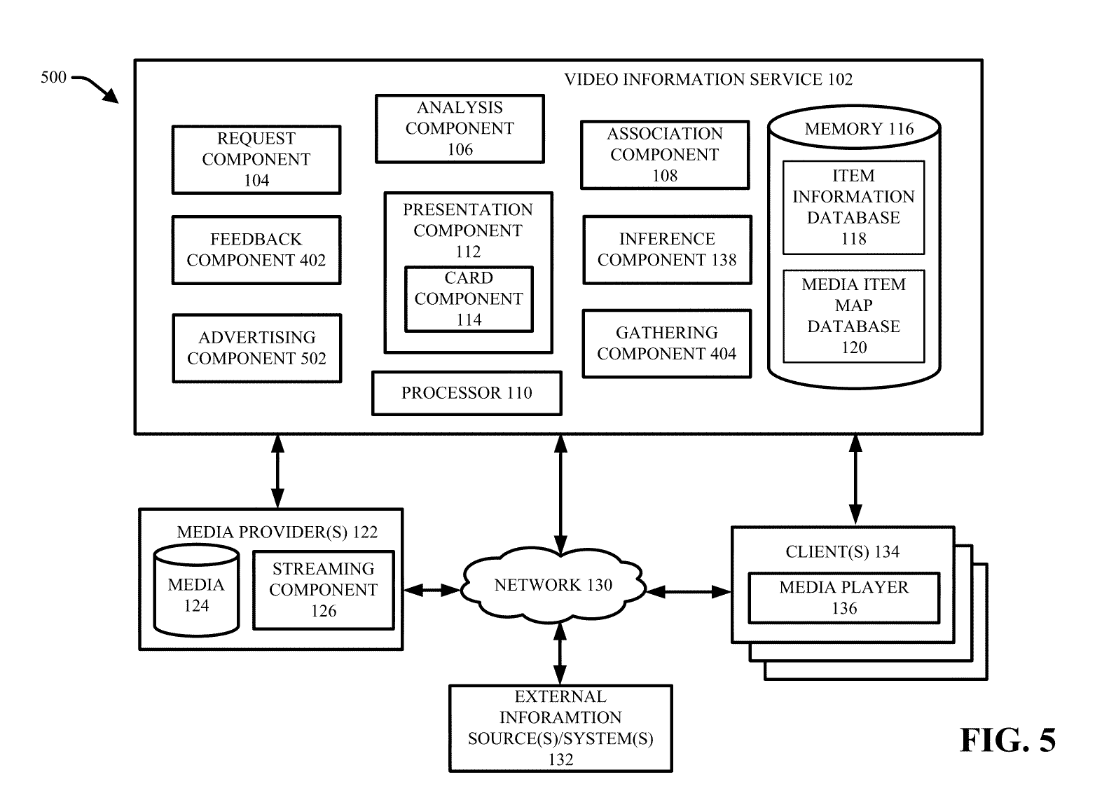

Referring to FIG. 5, presented is another example embodiment of a system 500 for surfacing information about items mentioned or presented in a media item in association with consumption of the media item in accordance with various aspects described herein. System 500 is similar to system 100 with the exception of the addition of advertising component 502. Repetitive description of like elements employed in respective embodiments of systems and interfaces described herein are omitted for sake of brevity.

Advertising component 502 is configured to present an advertisement in conjunction with additional information presented about a user interest item by presentation component 112. In particular, after the analysis component 106 has identified one or more user interest items associated with a user request for additional information regarding a section of a video and/or a particular object in the section of the video, the advertising component 502 is configured to identify an advertisement based on the identified one or more user interest items. The advertising component 502 can then present the advertisement to a user with the additional information presented by the presentation component. In an aspect, the advertisement can include a still image, an interactive tool-kit, or a video played in association with presentation of the additional information.

In an aspect, the advertisement can be pre-associated with the user interest object in memory 116. In another aspect, the advertising component 502 can scan one or more external information sources/systems 132 to identify the advertisement. The advertisement can further be related or unrelated to the identified one or more user interest items affiliated with a user request. For example, where a user is presented with additional information about a particular, item (e.g., a watch worn by an actor), the advertising component 502 can present the user with an advertisement about the watch.

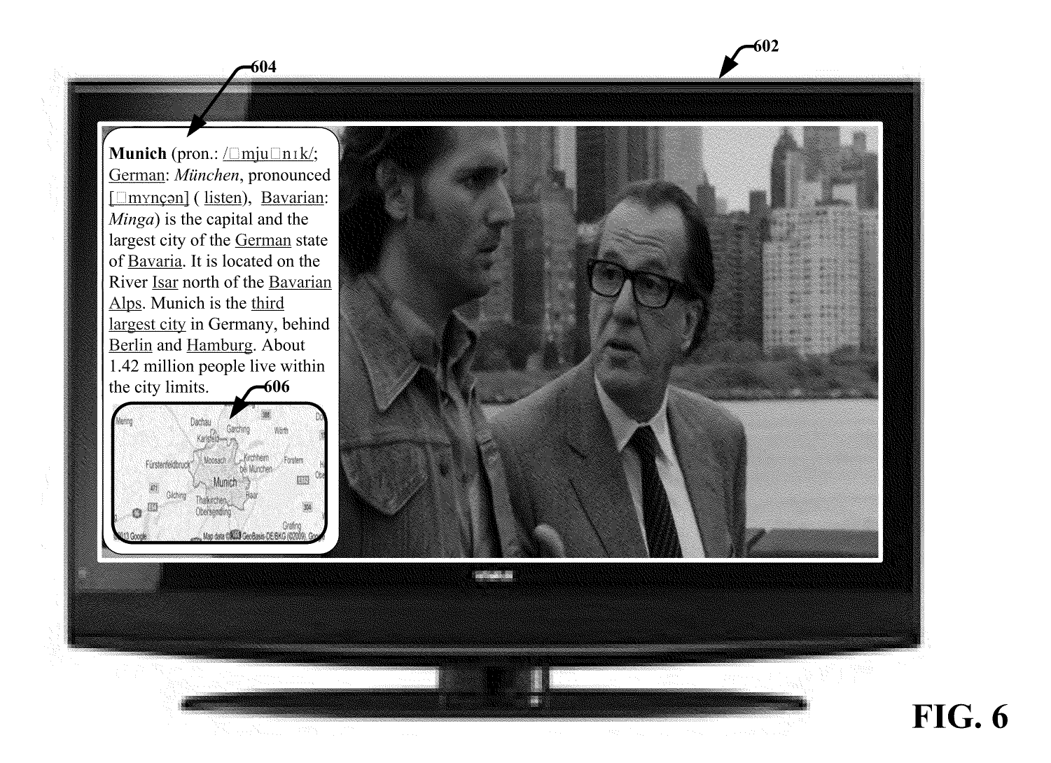

FIG. 6 illustrates an example embodiment of a user interface 600 having additional information presented to a user in association with a user interest item mentioned in a video that a user has expressed interest in. In FIG. 6, a client device, (e.g., such as a television, a computer, or a smartphone), has played a video and paused the video at the frame displayed. When employing a video information service (e.g., service 102), a request component has identified the pausing event as a request for additional information about one or more user interest item affiliated with the frame presented at or near the pausing event. The frame associated with the pausing event is further related to the user interest item “Munich,” as determined by an analysis component. An association component has retrieved additional information about the word “Munich” and a presentation component has presented the additional information to a user. As seen in FIG. 6, the additional information is displayed as an item information card 604 presented as an overly item on the video screen. The item information card 604 includes a brief description of the word “Munich” and a map depiction 606 of the city “Munich.” In an aspect, a user can click or select the map to enlarge the map and/or select various highlighted items in the description to receive additional information about the highlighted items.

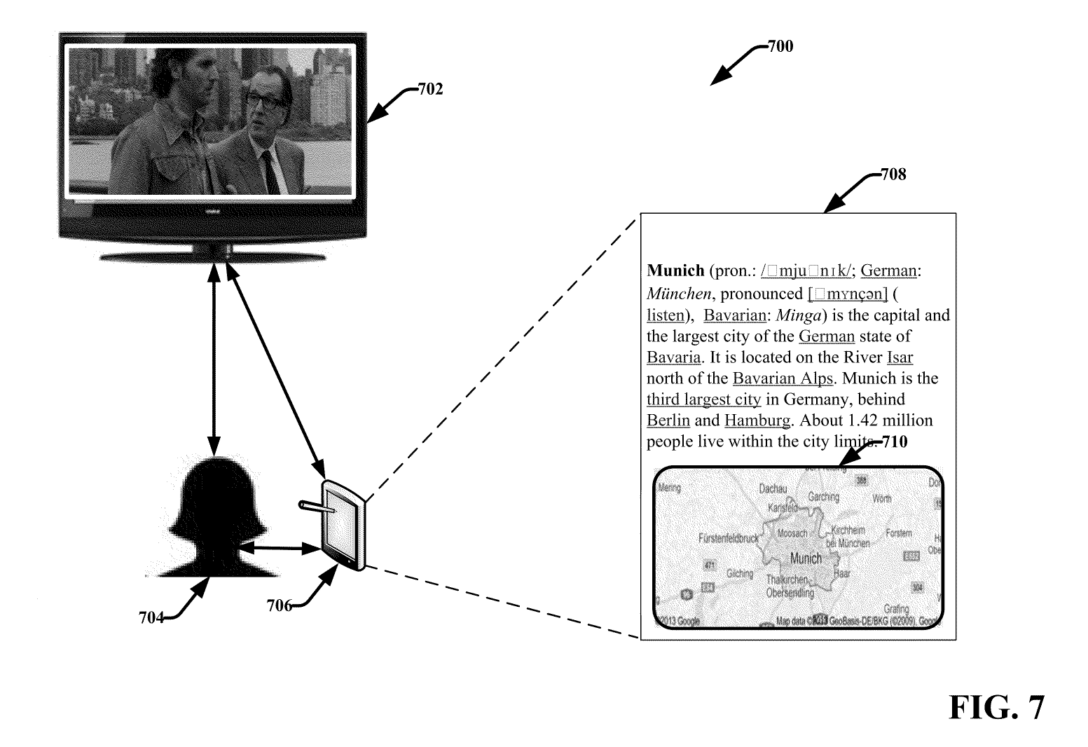

FIG. 7 illustrates an example embodiment of an example system 700 for receiving and presenting additional information regarding a user interest item mentioned or presented in a video. In system 700, a user 704 is watching a video on a first client device 702, client device and has paused the video at the frame displayed. When employing a video information service (e.g., service 102), a request component has identified the pausing event as a request for additional information about one or more user interest item affiliated with the frame presented at or near the pausing event. In this example, the frame associated with the pausing event is further related to the user interest item “Munich,” as determined by an analysis component. An association component has retrieved additional information about the word “Munich” and a presentation component has presented the additional information to a user at a second client device 706 employed by the user (e.g. a tablet PC). As seen in FIG. 7, the additional information is displayed as an item information card 708 presented at the second device 706. The item information card 708 includes a brief description of the word “Munich” and a map depiction 710 of the city “Munich.” In an aspect, a user can employ the tablet PC 706 to explore and interact with the item information card. For example, the user 704 can click or select the map to enlarge the map and/or select various highlighted items in the description to receive additional information about the highlighted items.

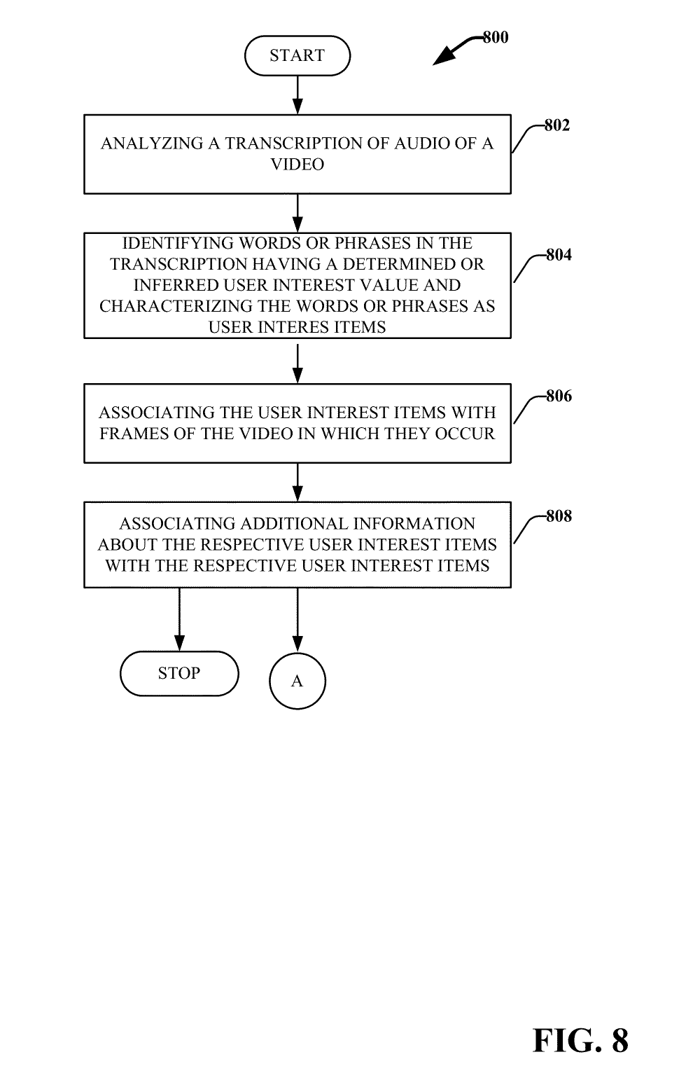

In view of the example systems and/or devices described herein, example methods that can be implemented in accordance with the disclosed subject matter can be further appreciated with reference to flowcharts in FIGS. 8-11. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 8 illustrates a flow chart of an example method 800 for facilitating identifying user interest items in a media item when the media item is played/viewed in accordance with aspects described herein. Method 800 relates to processing of a video prior to consumption of the video so as to at least generate a mapping of user interest items in the video to frames or sections in which they occur. At 802, a transcription of audio of a video is analyzed (e.g., using transcription analysis component 202). At 804, words or phrases in the transcription having a determined or inferred user interest value are identified and characterized as user interest items (e.g., using transcription analysis component 202). At 806, the user interest items are associated with frames of the video in which they occur (e.g., using association component 108). For example, the association component 108 can generate video information map that maps the user interest items to the frames of the video in which they occur and store the map in a database (e.g., media item map database 120). At 808, additional information about the respective user interested items is associated with the respective interest items (e.g., using association component 108). (In another aspect, step 808 can be performed at later time in association with a user request for additional information about one or more items mentioned in the video during consumption of the video). After step 808, method 800 can be completed or continue on from point A, as described with respect to method 800 in FIG. 8.

In accordance with step 808, in addition to information mapping the user interest items to the frames in the video in which they occur, the video information map created by the association component 108 can include a mapping of the user interest items to additional information about the respective user interest items, where the additional information is stored in at various internal (e.g., item information database 118) and/or external data sources (e.g., external information sources 132). In another example, the video information map created by the association component 108 can include a mapping of the user interest items to additional information about the respective user interest items, where the additional information is extracted from various sources and stored with the map (e.g., in media item map database 120). According to this example, the video information map can be downloaded by a client prior to consumption of the associated video and used by a local version of the disclosed video information service 102 (e.g., having at least a request component 104, an analysis component 106 and a presentation component 112) to provide additional information regarding user interest items to a user during consumption of the video.

In addition to the various embodiments described in this disclosure, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described in this disclosure, and similarly, storage can be effected across a plurality of devices. Accordingly, the invention is not to be limited to any single embodiment, but rather can be construed in breadth, spirit and scope in accordance with the appended claims.

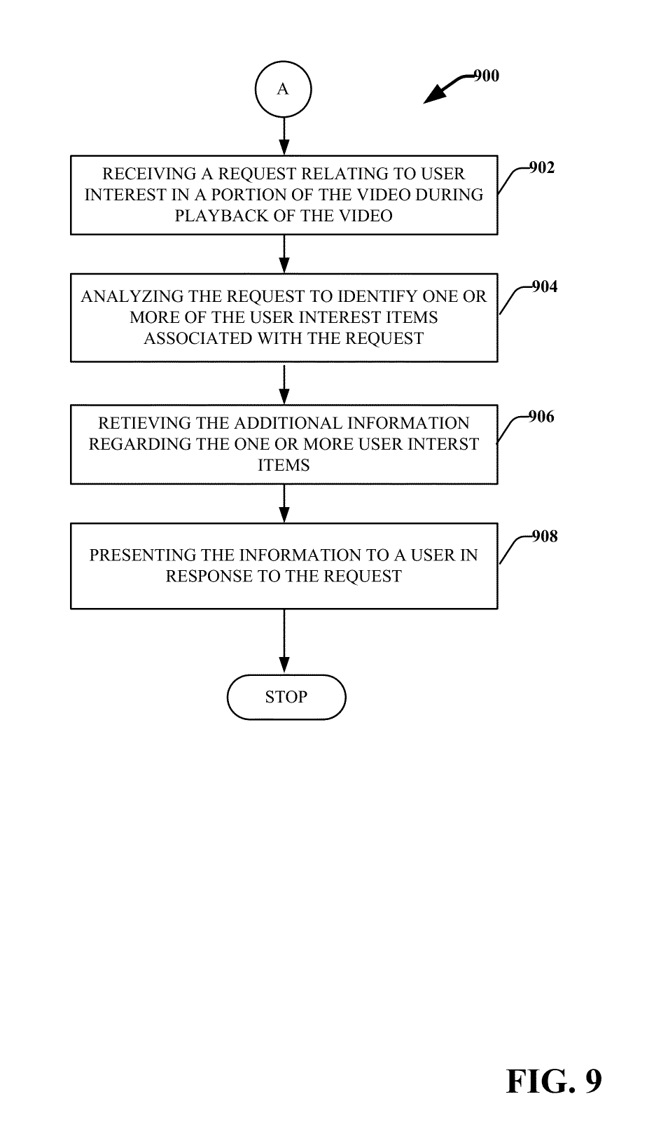

FIG. 9 illustrates a flow chart of an example method 900 for identifying user interest items in a media item when the media item is played/viewed in accordance with aspects described herein. Method 900 continues on from point A of method 800. At 902, a request relating to user interest in a portion of the video during playback of the video is received (e.g., using request component 104). For example, the request component 104 can identify a portion or point of the video where the video is paused by a user (e.g., point 1:02: 29) and interpret this pausing event as a request for additional information about one or more items associated with the portion or point in the video where the video is paused. At 904, the request is analyzed to identify one or more of the user interest items associated with the request (e.g., using analysis component 200). For example, the analysis component 200 can infer or determine that the portion of the video the user is interested in includes the portion of the video starting at about time point 1:02: 09 and ending at about time point 1: 02: 45 (e.g., based on a pausing point of 1:02: 29). The analysis component 200 can then identify (e.g. using the video information map previously generated by the association component 108 and stored in media item map database 120) one or more of the user interest items mapped to the portion of the video spanning point 1:02:09 to point 1:02:45.

At 906, additional information about the one or more user interest items is retrieved (e.g., using association component 108). For example, the association component 108 can employ a previously generated map (e.g., a video information map stored in media item map database 120) that maps the one or more user interest items to additional information to retrieve the additional information. In another example, the association component 108 can at this time perform a query against one or more internal (e.g., item information database 118) or external (external information source/system 132) data sources to retrieve the additional information. Then at 908, after the association component has retrieved the additional information, the additional information is presented to a user in response to the request (e.g., using presentation component 112). For example, the presentation component 112 can generate a card or tool-kit that includes the additional information for the one or more items and cause the card or tool-kit to be displayed on a display screen at which the video is being consumed by the user (e.g., either in a pause mode or while continuing to play).

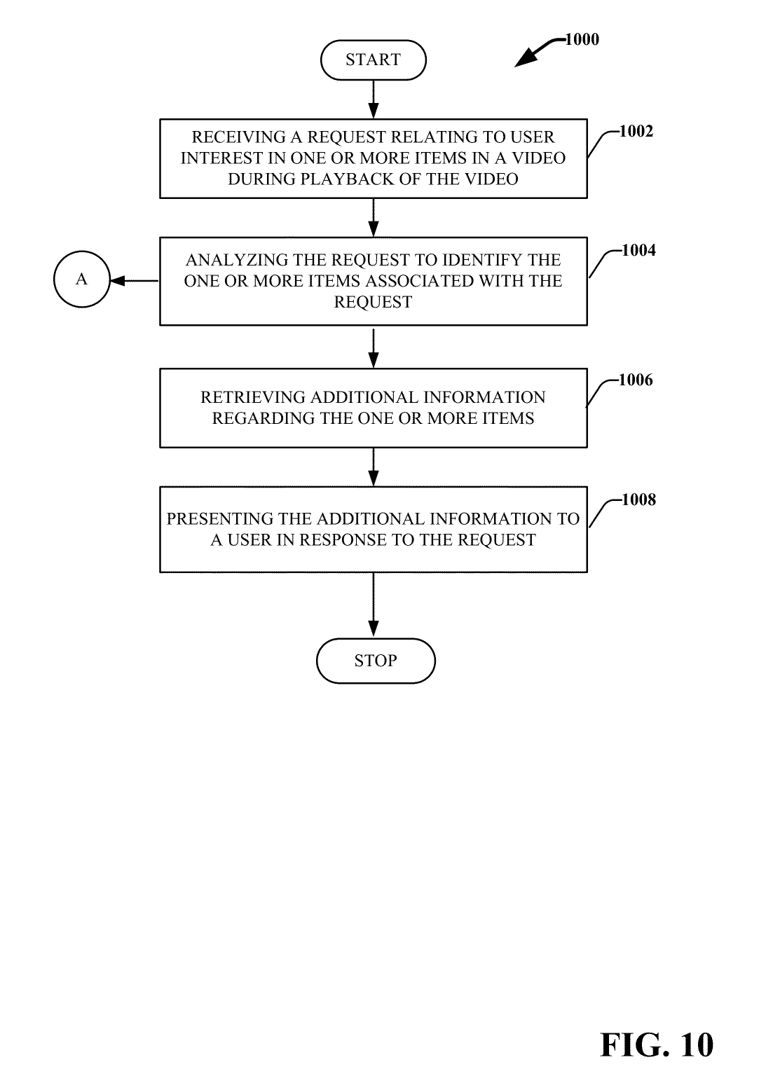

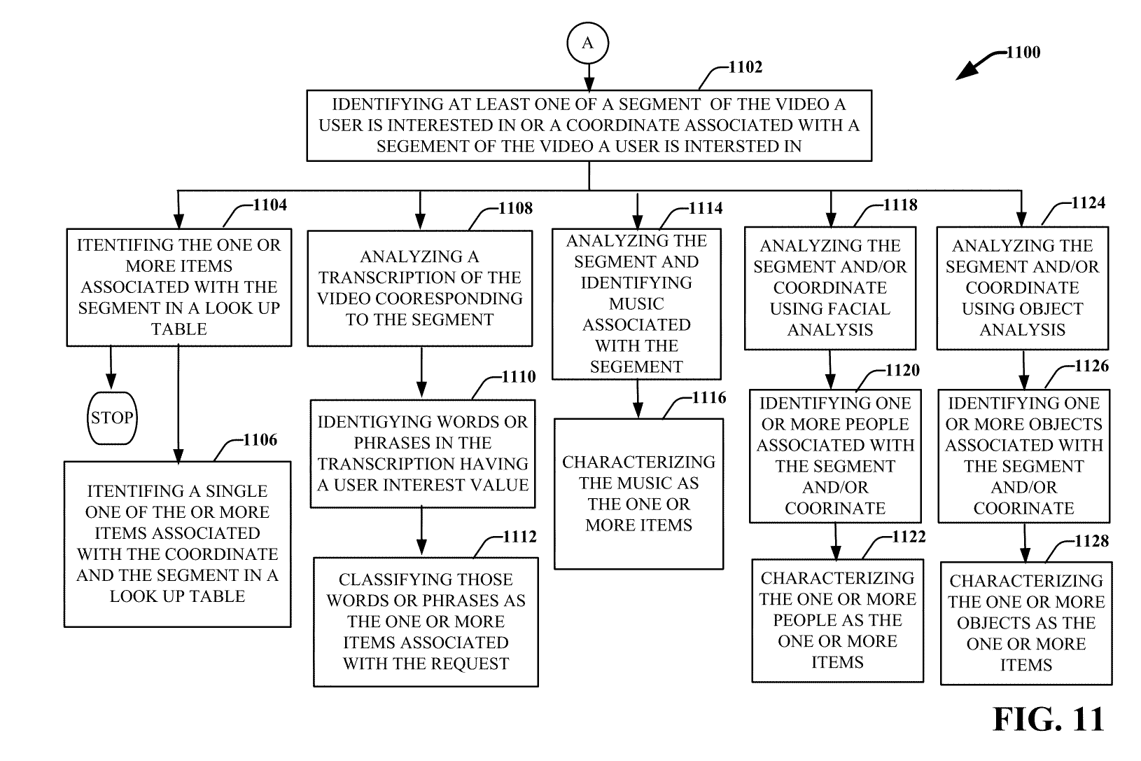

FIG. 10 illustrates a flow chart of an example method 1000 for identifying user interest items in a media item when the media item is played/viewed in accordance with aspects described herein. At 1002, a request relating to user interest in one or more items in a video during playback of the video is received (e.g., using request component 104). At 1004, the request is analyzed to identify the one or more items associated with the request (e.g., using analysis component 200). The type of analysis performed by the analysis component 200 at step 1004 will vary depending on the information included in the request and/or whether any pre-processing (e.g., mapping of items in the video to sections and/or coordinates) has been performed on the video. The various types of analysis that the analysis component 200 could perform at step 1004 are discussed with respect to FIG. 11. At 1006, additional information regarding the one or more items is retrieved, (e.g., using association component 108), and at 1008 the additional information is presented to the user in response to the request (e.g., using presentation component 112).

FIG. 11 illustrates a flow chart 1100 of example analysis methods that could be performed in association with step 1004 of method 1000. Chart 1100 continues from point A of method 1000. At 1102, at least one or a segment of the video a user ins interested in or a coordinate associated with a segment of the video the user is interested is identified. For example, request could indicate a user paused a video at about segment 10. The request could also indicate that the user pointed to the video screen and targeted coordinate (−2, 16) when the video was paused at about segment 10. Steps 1104 to 1106 relate to analysis of the request using information previously processed about the video that maps user interest items to segments and/or coordinates of the video. For example, at step 1004, one or more items associated with the segment are identified in a look-up table (e.g., a video item map stored in media item map database 120). If the request further indicates a coordinate, the one or more items associated with the segment can further be analyzed by the analysis component 200 to single out a single item that the user is interested in related to the segment. For example, at step 1106, a single one of the one or more items associated with the coordinate and the segment is identified using a look-up table (e.g., a video item map stored in media item map database 120 that further associates segments and coordinates to user interest items for a video).

Steps 1108 through 1128 relate to analysis that may be performed where not pre-processing of the video has been performed by video information service 1102. In an aspects, one or more of steps 1108-1112, steps 1114-1116, steps 1118-1122 or steps 1124-1128 can be performed to identify the one or more items associated with the request. Further, although not pictured in FIG. 11, the analysis component 200 can further analyze the segment and/or coordinate based on additional information relating to at least one of user preferences, trending items, user location, or user demographics to facilitate inferring one or more items that the user is likely interest in included in the video segment and/or coordinate.

At 1108, a transcription of the video corresponding to the segment is analyzed (e.g., using transcription analysis component 202). At 1110, words or phrases in the transcription having a user interest value are identified (e.g., using transcription analysis component 202), and at 1112, those word and phrases are classified as the one or more items associated with the request (e.g., using transcription analysis component 202).

At 1114, the segment is analyzed and music associated with the segment is identified (e.g., using music analysis component 206). At 1116, the music is characterized as the one or more items the user is interested in. (e.g., using music analysis component 206). At 1118, the segment and/or the coordinate is analyzed using facial analysis (e.g., using facial recognition analysis component 208). At 1120, one or more people associated with the segment and/or the coordinate are identified and at 1122, the one or more people are characterized as the one or more items (e.g., using facial recognition analysis component 208). At 1124 the segment and/or the coordinate is analyzed using object analysis (e.g., using object analysis component 211). At 1126, one or more objects associated with the segment and/or the coordinate are identified and at 1128, the one or more objects e are characterized as the one or more items (e.g., using object analysis component 208).

In situations in which the systems discussed herein collect personal information about users, or may make use of personal information (e.g. information pertaining to user preferences, user demographics, user location, viewing history, social network affiliations and friends and etc.), the users may be provided with an opportunity to control whether programs or features collect user information, or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (e.g. to a city, Zip code, or state level), so that a particular location of a user cannot be determined. Thus, the user may have control over how information is collected about the user and used by a content server.

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

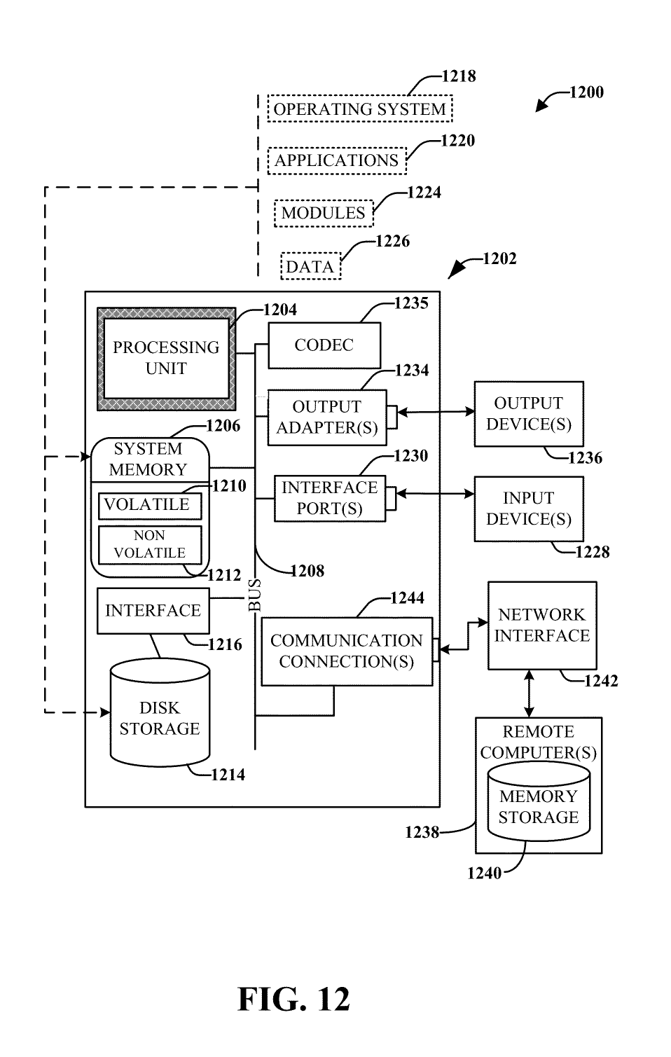

With reference to FIG. 12, a suitable environment 1200 for implementing various aspects of the claimed subject matter includes a computer 1202. The computer 1202 includes a processing unit 1204, a system memory 1206, a codec 1205, and a system bus 1208. The system bus 1208 couples system components including, but not limited to, the system memory 1206 to the processing unit 1204. The processing unit 1204 can be any of various available processors. Dual microprocessors and other multiprocessor architectures also can be employed as the processing unit 1204.

The system bus 1208 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13124), and Small Computer Systems Interface (SCSI).

The system memory 1206 includes volatile memory 1210 and non-volatile memory 1212. The basic input/output system (BIOS), containing the basic routines to transfer information between elements within the computer 1202, such as during start-up, is stored in non-volatile memory 1212. In addition, according to present innovations, codec 1205 may include at least one of an encoder or decoder, wherein the at least one of an encoder or decoder may consist of hardware, a combination of hardware and software, or software. Although, codec 1205 is depicted as a separate component, codec 1205 may be contained within non-volatile memory 1212. By way of illustration, and not limitation, non-volatile memory 1212 can include read only memory (ROM), programmable ROM (PROM), electrically programmable ROM (EPROM), electrically erasable programmable ROM (EEPROM), or flash memory. Volatile memory 1210 includes random access memory (RAM), which acts as external cache memory. According to present aspects, the volatile memory may store the write operation retry logic (not shown in FIG. 12) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1202 may also include removable/non-removable, volatile/non-volatile computer storage medium. FIG. 12 illustrates, for example, disk storage 1214. Disk storage 1214 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1214 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1214 to the system bus 1208, a removable or non-removable interface is typically used, such as interface 1216.

It is to be appreciated that FIG. 12 describes software that acts as an intermediary between users and the basic computer resources described in the suitable operating environment 1200. Such software includes an operating system 1218. Operating system 1218, which can be stored on disk storage 1214, acts to control and allocate resources of the computer system 1202. Applications 1220 take advantage of the management of resources by operating system 1218 through program modules 1224, and program data 1226, such as the boot/shutdown transaction table and the like, stored either in system memory 1206 or on disk storage 1214. It is to be appreciated that the claimed subject matter can be implemented with various operating systems or combinations of operating systems.

A user enters commands or information into the computer 1202 through input device(s) 1228. Input devices 1228 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1204 through the system bus 1208 via interface port(s) 1230. Interface port(s) 1230 include, for example, a serial port, a parallel port, a game port, and a universal serial bus (USB). Output device(s) 1236 use some of the same type of ports as input device(s). Thus, for example, a USB port may be used to provide input to computer 1202, and to output information from computer 1202 to an output device 1236. Output adapter 1234 is provided to illustrate that there are some output devices 1236 like monitors, speakers, and printers, among other output devices 1236, which require special adapters. The output adapters 1234 include, by way of illustration and not limitation, video and sound cards that provide a means of connection between the output device 1236 and the system bus 1208. It should be noted that other devices and/or systems of devices provide both input and output capabilities such as remote computer(s) 1238.

Computer 1202 can operate in a networked environment using logical connections to one or more remote computers, such as remote computer(s) 1238. The remote computer(s) 1238 can be a personal computer, a server, a router, a network PC, a workstation, a microprocessor based appliance, a peer device, a smart phone, a tablet, or other network node, and typically includes many of the elements described relative to computer 1202. For purposes of brevity, only a memory storage device 1240 is illustrated with remote computer(s) 1238. Remote computer(s) 1238 is logically connected to computer 1202 through a network interface 1242 and then connected via communication connection(s) 1244. Network interface 1242 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1244 refers to the hardware/software employed to connect the network interface 1242 to the bus 1208. While communication connection 1244 is shown for illustrative clarity inside computer 1202, it can also be external to computer 1202. The hardware/software necessary for connection to the network interface 1242 includes, for exemplary purposes only, internal and external technologies such as, modems including regular telephone grade modems, cable modems and DSL modems, ISDN adapters, and wired and wireless Ethernet cards, hubs, and routers.

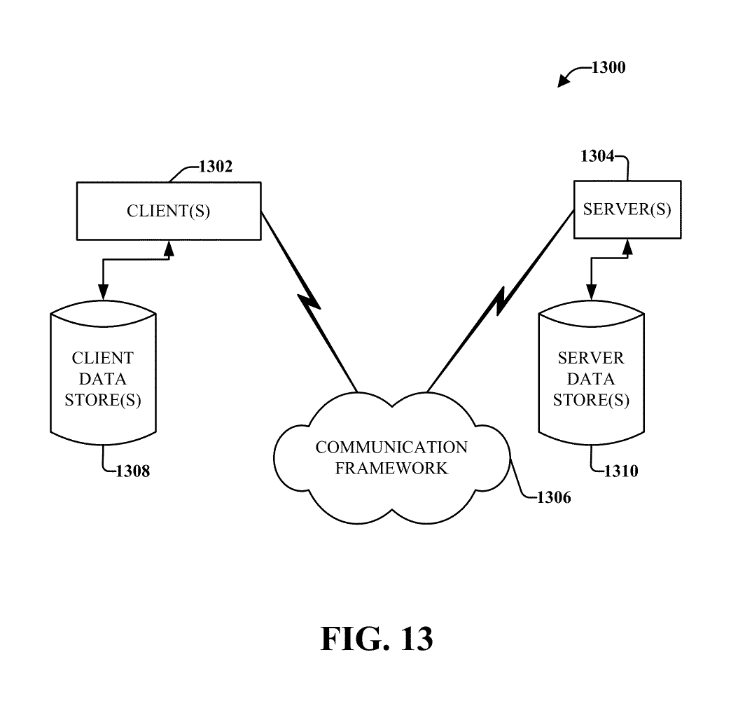

Referring now to FIG. 13, there is illustrated a schematic block diagram of a computing environment 1300 in accordance with this disclosure. The system 1300 includes one or more client(s) 1302 (e.g., laptops, smart phones, PDAs, media players, computers, portable electronic devices, tablets, and the like). The client(s) 1302 can be hardware and/or software (e.g., threads, processes, computing devices). The system 1300 also includes one or more server(s) 1304. The server(s) 1304 can also be hardware or hardware in combination with software (e.g., threads, processes, computing devices). The servers 1304 can house threads to perform transformations by employing aspects of this disclosure, for example. One possible communication between a client 1302 and a server 1304 can be in the form of a data packet transmitted between two or more computer processes wherein the data packet may include video data. The data packet can include a metadata, e.g., associated contextual information, for example. The system 1300 includes a communication framework 1306 (e.g., a global communication network such as the Internet, or mobile network(s)) that can be employed to facilitate communications between the client(s) 1302 and the server(s) 1304.

Communications can be facilitated via a wired (including optical fiber) and/or wireless technology. The client(s) 1302 include or are operatively connected to one or more client data store(s) 1308 that can be employed to store information local to the client(s) 1302 (e.g., associated contextual information). Similarly, the server(s) 1304 are operatively include or are operatively connected to one or more server data store(s) 1313 that can be employed to store information local to the servers 1304.

In one embodiment, a client 1302 can transfer an encoded file, in accordance with the disclosed subject matter, to server 1304. Server 1304 can store the file, decode the file, or transmit the file to another client 1302. It is to be appreciated, that a client 1302 can also transfer uncompressed file to a server 1304 and server 1304 can compress the file in accordance with the disclosed subject matter. Likewise, server 1304 can encode video information and transmit the information via communication framework 1306 to one or more clients 1302.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. A system, comprising:
a memory having stored thereon computer executable components;
a processor that executes at least the following computer executable components:
an analysis component that analyzes media and identifies items in the media that have a user interest value;
an association component that retrieves background information regarding the identified items; and
a presentation component that presents the background information to a user in association with playback of the media.

2. The system of claim 1, wherein the presentation component presents the background information to the user in response to occurrence of the media idem during playback of the media item.

3. The system of claim 1, further comprising:
a request component that receives a request relating to user interest in a portion of the media during playback of the media, wherein the analysis component analyzes the request and identifies one or more items in the media associated with the request that have a user interest value and wherein the presentation component presents background information for the one or more items in response to the request.

4. The system of claim 1, wherein the presentation component presents the user with tool-tips that respectively display the background information.

5. The system of claim 3, wherein the analysis component searches sections of the media played at or prior to receipt of the request, and identifies audio or video portions that have a high probability of user interest.

6. The system of claim 1, wherein the analysis component analyzes closed captioned text associated with the media.

7. The system of claim 1 implemented by a server that is streaming the media to a user.

8. The system of claim 1 implemented by a client-side device.

9. A method comprising:
using a processor to execute the following computer executable instructions stored in a memory to perform the following acts:
analyzing a transcription of audio of a video;
identifying words or phrases in the transcription having a determined or inferred user interest value;
associating additional information about the respective words or phrases with the respective words or phrases; and
associating the words or phrases with frames of the video in which they occur.

10. The method of claim 9, further comprising:
presenting the additional information to a user when the words or phrases occur during the playing of the video.

11. The method of claim 9, further comprising:
presenting the additional information to a user when the words or phrases occur in a frame of the video associated with a pausing of the video.

12. The method of claim 9, further comprising:
receiving a request to pause the video during a playing of the video on a display;
identifying a frame of the video associated with the point where the video has been paused;
identifying words or phrases in the frame that have the respective additional information associated therewith; and
presenting the information for those words or phrases on the display at which the video is paused.

13. The method of claim 12, wherein the identifying the frame of the video associated with the point where the video has been paused includes identifying a frame of video comprising a predetermined window of time that occurs immediately preceding the point where the video has been paused.

14. The method of claim 9, wherein the associating the additional information about the respective words or phrases with the respective words or phrases includes:
issuing a query for the respective additional information against a database comprising the additional information pre-associated with the respective words and phrases;
extracting the respective additional information from the database; and
generating respective data cards having the respective additional information for the respective words or phrases.

15. The method of claim 9, wherein the identifying the words or phrases in the transcription having the determined user interest value includes identifying word or phrases in the transcription that have been previously recorded in an index.

16. The method of claim 15, wherein the index comprises a plurality of known words and phrases having the additional informational associated therewith.

17. A tangible computer-readable storage medium comprising computer-readable instructions that, in response to execution, cause a computing system to perform operations, comprising:
analyzing a transcription of audio of a video;
identifying words or phrases in the transcription that are included in a database comprising a plurality of known words and phrases with respective additional information about the respective known words and phrases respectively associated therewith; and
associating the words or phrases with frames of the video in which they occur.

18. The computer readable medium of claim 17, the operations further comprising presenting the respective additional information for the words or phrases to a user when the words or phrases occur during the playing of the video.

19. The computer readable medium of claim 17, the operations further comprising presenting the respective additional information for the words or phrases to a user when the words or phrases occur in a frame of the video associated with a pausing of the video.

20. The computer readable medium of claim 19, the operations further comprising identifying an advertisement related to the words or phrases and presenting the advertisement to a user when the words or phrases occur in the frame of the video associated with the pausing of the video.
